(19) United States
(12) Patent Application Publication
(10) Pub. No.: US 2008/0252871 A1
(43) Pub. Date: Oct. 16, 2008

(54) Projection exposure apparatus

(75) Inventors: Jin Sato, Tokyo (JP); Masaru Yamaga, Tokyo (JP); Akira Nakazawa, Tokyo (JP); Koutatsu Kudo, Tokyo (JP); Yuken Nakamoto, Tokyo (JP)

Correspondence Address: DILWORTH & BARRESE, LLP, 333 EARLE OVINGTON BLVD., SUITE 702, UNIONDALE, NY, 11553, US

(73) Assignee: ORC Manufacturing Co., Ltd., Tokyo (JP)

(21) Appl. No.: 12/069,415

(22) Filed: Feb. 8, 2008

(30) Foreign Application Priority Data
Apr. 13, 2007 (JP) 2007-105396
Jun. 15, 2007 (JP) 2007-158867
Oct. 23, 2007 (JP) 2007-274791
Nov. 16, 2007 (JP) 2007-297696

(51) Int. Cl. G03B 27/70; G03B 27/72

(52) U.S. Cl. 355/66; 355/71

(57) ABSTRACT

The present invention relates to a projection exposure apparatus that forms predetermined patterns onto a substrate. The projection exposure apparatus for forming patterns onto a substrate, which includes a mask-stage for holding a photo-mask having predetermined patterns thereon, a light source for emitting a light ray containing spectral lines including g, h, i and j-lines, a wavelength selector for selecting a light ray containing predetermined spectral lines from the light ray emitted from the light source, an illumination optical system for irradiating the photo-mask with the selected light ray, an Offner type projection system for projecting the light having passed through the photo-mask onto the substrate, a substrate stage including a vacuum portion for holding the substrate, the substrate stage for positioning the substrate, and a light-shielding body for partially blocking the light irradiated to the substrate.

### CROSS-REFERENCE TO RELATED APPLICATIONS

This application claims the benefits of Japanese Patent Applications 2007-105396, 2007-158867, 2007-274791 and 2007-297696 filed on Apr. 13, 2007, Jun. 15, 2007, Oct. 23, 2007 and Nov. 16, 2007, respectively, the disclosures of which are incorporated herein by reference.

### BACKGROUND OF THE INVENTION

1. Field of the Invention

The present invention relates to a projection exposure apparatus that forms predetermined patterns onto a substrate for an electronic circuit, a glass substrate for a liquid crystal element or a PDP, and other plane materials.

2. Description of the Related Art

Generally, a projection exposure apparatus is used to form predetermined patterns onto a semiconductor substrate for a silicon wafer, a glass substrate for a liquid crystal element or a PDP, and an electronic circuit substrate (referred to as a “substrate” herein). Since such projection exposure apparatuses are under development, many types of them have been proposed. A typical type projection exposure apparatus uses monochromatic light of a short-wavelength to form fine patterns.

When patterns are formed on a thick photo-resist film for applications such as micro electro mechanical systems (MEMS), chips scale package (CSP) or bumping process, a projection exposure apparatus may require an exposure amount of as high as 1500 mJ/cm². If the apparatus uses monochromatic light to produce such a high exposure amount, then its exposure time ends up considerably long. This leads to the low efficiency of the exposure process.

JP A 2006-512618 discloses a projection exposure apparatus equipped with a catadioptric system in which the chromatic aberrations at g, h and i-line wavelengths are corrected. However, this optical system may fail to correct the chromatic aberration, if a spectral range is broader than a range at the g to i-lines. In addition, the imaging point of the optical system may be displaced due to heat generated in the lenses.

JP A H07-094404 discloses a catoptric projection exposure apparatus composed of plane, convex and concave mirrors. However, this apparatus does not meet a requirement for forming fine patterns efficiently by increasing the intensity of the light.

On the other hand, as an exposure area on a substrate is wider, optical members of a projection exposure apparatus are larger. This involves the enlargement of the concave mirror and its holder, which may cause the barrel to be bent because of their own weight. Accordingly, it becomes difficult to align the principal axis of individual optical members to the optical axis of the optical system with precision. To demonstrate, the axis of the concave mirror tends to be displaced with time. Furthermore, since a cylindrical-shaped barrel typically covers the whole surfaces of mirrors, gas generated from a photo-resist coated on a substrate stays within the barrel and may fog the mirror surfaces during an exposure process. In addition, the exposure light is prone to increase the temperature of interior of the barrel, thus causing the fluctuation of air therein. This leads to the deterioration of property in which an optical system forms an image.

When a substrate on which a thick photo-resist film is formed is handled, its film thickness tends to be non-uniform around the edges of the substrate. This non-uniform part of the film may be left as it is, and become contaminants in a downstream process. Hence, the photo-resist film formed around the edge of a substrate needs to be removed completely. In order to overcome this disadvantage, JP A 2005-505147 and JP A H07-106242 disclose an exposure apparatus equipped with a light-shielding plate which can remove a photo-resist from the rim of a substrate by protecting the rim from the exposure light.

However, the light-shielding body of JPA 2005-505147, which covers the whole surface of a substrate, is difficult to handle. Especially, it takes a long time to exchange the light-shielding bodies or substrates, thereby degrading the process efficiency. This enlarged light-shielding body is prone to bear great air resistance to thereby blow up dust. Meanwhile, the light-shielding body of JP A H07-106242 is designed for applications of positive type resist films. In addition, it does not clearly disclose a control mechanism for the light-shielding body.

Taking the above disadvantages into account, the present invention has been conceived.

An object of the present invention is to provide a projection exposure apparatus which:
1) can irradiate a photo-resist coated on a substrate with light of high intensity and over a broad spectral range containing multiple spectral lines on the condition that the chromatic aberration is corrected or the projected image is not defocused;
2) can select one or more desired spectral lines from multiple spectral lines, depending on the types of a photo-resist film;
3) is equipped with a strong and lightweight barrel in which the air is hardly fluctuated;
4) is provided with a light-shielding body that forms a light-shielding area by blocking the exposure light irradiated to the edge of a substrate, and that can be removed or reset promptly upon exchange of substrates or change in light-shielding areas; and
5) possesses a control mechanism for the above light-shielding body.

### SUMMARY OF THE INVENTION

According to a first aspect of the present invention, there is provided, a projection exposure apparatus for forming patterns onto a substrate, comprising:
a1) a mask-stage for holding a photo-mask having predetermined patterns thereon;
a2) a light source for emitting a light ray containing a plurality of spectral lines including g, h, i and j-lines, which are spectral lines of mercury (i.e. 436 nm, 405 nm, 365 nm and 313 nm, respectively);
a3) a wavelength selector for selecting a light ray containing one or more predetermined spectral lines from the light ray emitted from the light source;
a4) an illumination optical system for irradiating the photo-mask with the light containing the selected light ray;
a5) an Offner type projection system for projecting the light having passed through the photo-mask onto the substrate;
a6) a substrate stage including a chuck for fixing the substrate by means of vacuum attraction, the substrate stage for positioning the substrate; and
a7) a light-shielding body for partially blocking the light irradiated to the substrate.

In the projection exposure apparatus of the first aspect, the wavelength selector can appropriately control the spectral range and the intensity of the exposure light. In addition, the Offner type projection system possesses the corrected chromatic aberration, thereby preventing the image from being defocused. Consequently, it is possible to provide the projection exposure apparatus that has ability to irradiate a substrate with the light ray having high intensity and a broad spectral range without causing the chromatic aberration or defocusing the projected image.

According to a second aspect of the present invention, there is provided, the projection exposure apparatus according to the first aspect, in which the Offner type projection system includes a barrel having a circumference on which a plurality of polygonal openings are formed, and the barrel comprises:
b1) a first mirror for reflecting the light having passed through the photo-mask;
b2) a second mirror for reflecting the light having been reflected by the first mirror;
b3) a third mirror for reflecting the light having been reflected by the second mirror; and
b4) a fourth mirror for reflecting the light having been reflected by the third and second mirrors in this order.

In the projection exposure apparatus of the second aspect, because of the openings on the barrel, the Offner type projection system is made lightweight. In addition, air flows into/out of the interior of the barrel via the openings, thus decreasing the fluctuation of the air therein. Moreover, if the openings are polygonal, then the displacement of the barrel is reduced, so that the rigidity of the barrel is improved. As a result, it is possible to provide the projection exposure apparatus that is equipped with a strong and lightweight barrel in which the air is hardly fluctuated

According to a third aspect of the present invention, there is provided, the projection exposure apparatus according to the first aspect, in which the light-shielding body comprises:
c1) a first light-shielding body for blocking the light;
c2) a first light-shielding body positioning portion for placing the first light-shielding body above a rim of the substrate; and
c3) a moving portion for traveling the first light-shielding body positioning portion to any given location around the substrate, the moving portion being placed on the substrate stage.

According to a fourth aspect of the present invention, there is provided, the projection exposure apparatus according to the third aspect, in which the first light-shielding body positioning portion rotates around an axis that is parallel to the substrate.

According to a fifth aspect of the present invention, there is provided, the projection exposure apparatus according to the third aspect, in which the light-shielding body further comprises:
d1) a second light-shielding body positioning portion including a second light-shielding body that has a different shape from that of the first shielding body. In addition, the second light-shielding body positioning portion positions the second light-shielding body above the rim of the substrate. Furthermore, the moving portion travels the second light-shielding body positioning portion to any given location around the substrate.

According to a sixth aspect of the present invention, there is provided, the projection exposure apparatus according to the fifth aspect, in which a distance between the second light-shielding body and a center of the substrate is different from that between the first light-shielding body and the center.

In the projection exposure apparatus of one of the third to sixth aspects, the first or second light-shielding body blocks the light ray irradiated to the rim of the substrate, so that a blind zone to which no patterns are formed is defined. In addition, the first or second light-shielding body is rotated around an axis that is parallel to the substrate, whereby the substrate is exchanged for another simply by rotating it. Furthermore, since the first and second light-shielding bodies are arranged away from each other in the radial direction of the substrate, the light-shielding body can be applied to substrates of different diameters. Consequently, it is possible to provide the projection exposure apparatus which is equipped with a light-shielding body that can form the blind area on the substrate, and that can be removed or reset promptly upon exchange of substrates or change in light-shielding area.

Other aspects, features and advantages of the present invention will become apparent upon reading the following specification and claims when taken in conjunction with the accompanying drawings.

### BRIEF DESCRIPTION OF THE DRAWINGS

For more complete understanding of the present invention and the advantages hereof, reference is now made to the following description taken in conjunction with the accompanying drawings wherein:

FIG. 1 is a schematic view depicting a projection exposure apparatus 100 according to an embodiment of the present invention;

FIG. 2 is a schematic view depicting the projection exposure apparatus 100 with an illumination optical system 10 excluded;

FIG. 3 is a block diagram mainly depicting an optical system and a drive control section of the projection exposure apparatus 100;

FIG. 4 is a graph indicating a relationship between wavelength and light intensity of a mercury short arc lamp that is used as a light source 11;

FIG. 5 is a perspective view depicting a linear wavelength selector 15-1;

FIG. 6 is a perspective view depicting a rotation type wavelength selector 15-2;

FIG. 7 is a chart depicting an example of a combination of filters F11 to F14 and filters F21 to F24;

FIG. 8A is a view depicting a photo-mask M;

FIG. 8B shows a substrate CB having been subjected to an exposure process;

FIG. 9A is a flowchart of a process for aligning the photo-mask M;

FIG. 9B is a view depicting the movement of the photo-mask M during an alignment process;

FIG. 10A is a view depicting a masking blade 20 with third and fourth blades excluded, as seen from the top;

FIG. 10B is a view depicting the masking blade 20 with third and fourth blades excluded, as seen from the side;

FIG. 10C is another view depicting the masking blade 20 with third and fourth blades excluded, as seen from the top;

FIG. 10D is a view depicting a whole of the masking blade 20 as seen from the top;

FIG. 11A is a view depicting a masking blade 22;

FIG. 11B is a view depicting the masking blade 22;

FIG. 12A is an exploded view depicting a first catoptric projection system 50A as seen from the side of a concave mirror M2;

FIG. 12B is an exploded view depicting the first catoptric projection system 50A as seen from the side of a plane mirror M1;

FIG. 13 is an exploded perspective view depicting a second catoptric projection system 50B;

FIG. 14 is an exploded perspective view depicting a third catoptric projection system 50C;

FIG. 15A is a view depicting the catoptric projection system 50 undergoing a load on the condition that each of a first barrel 50-1 and a second barrel 50-2 has multiple triangular openings on the circumference;

FIG. 15B is a view depicting the catoptric projection system 50 undergoing a load on the condition that the first barrel 50-1 has multiple triangular openings on the circumference and the second barrel 50-2 has multiple circular openings;

FIG. 15C is a view depicting the catoptric projection system 50 undergoing a load on the condition that the first barrel 50-1 has multiple triangular openings on the circumference and the second barrel 50-2 has multiple hexagonal openings;

FIG. 16A is a view depicting a concave mirror M2 held by an elastic ring 52c;

FIG. 16B is a cross-sectional view depicting the concave mirror M2 taken along a line B-B of FIG. 16A;

FIG. 17A is a view depicting a substrate table 74 of FIG. 2 as seen from the top;

FIG. 17B is a view depicting a surrounding area of a first light-shielding body positioning portion 32;

FIG. 17C is a cross-sectional view depicting the first light-shielding body positioning portion 32 of FIG. 17B;

FIG. 18 is a first flowchart of the exposure process executed on the substrate table 74;

FIG. 19 is a second flowchart of the exposure process executed on the substrate table 74;

FIG. 20A is a cross-sectional view of a surrounding area of the first light-shielding body positioning portion 32-2 where the first light-shielding body 30 slides on the X-Y plane;

FIG. 20B is a view depicting the surrounding area of the first light-shielding body positioning portion 32-2 as seen from the top;

FIG. 21 is a view depicting the substrate table 74 having two light-shielding body positioning portions;

FIG. 22 is a view depicting another method of blinding the rim of the substrate;

FIG. 23A is a view depicting the light-shielding body 40 composed of multiple members as seen from the top;

FIG. 23B shows a cross-section of the surrounding area of the substrate table 74 taken along a D-D line of FIG. 23A;

FIG. 24A is a view depicting the setting of a first light-shielding body member 40A1;

FIG. 24B is a view depicting the setting of a second light-shielding body member 40B1;

FIG. 24C is a view depicting the setting of a third light-shielding body member 40C1;

FIG. 25A is a view depicting a light-shielding body 40 to be set on the support stage 41 of the substrate table 74 as seen from the top;

FIG. 25B is a cross-sectional view of the surrounding area of the substrate table 74 taken along a line D-D of FIG. 25A;

FIG. 26A is a view depicting the setting of a first light-shielding body member 40A2 on the support stage 41;

FIG. 26B is a view depicting the setting of a second light-shielding body member 40B2 on the support stage 41;

FIG. 26C is a view depicting the setting of a third light-shielding body member 40C2 on the support stage 41;

FIG. 27 is a flowchart of the exposure process and the substrate exchange process;

FIG. 28A is a cross-sectional view depicting a removal location E on a substrate stage 70 as seen in the X direction;

FIG. 28B is a view depicting the left side of FIG. 28A;

FIG. 29A is a cross-sectional view depicting a removal location E on the rim of the substrate stage 70 as seen in the X direction; and

FIG. 29B is a view depicting the side of FIG. 29A.

### DETAILED DESCRIPTION OF THE EXEMPLARY EMBODIMENTS OF THE INVENTION

### <Schematic Structure of Projection Exposure Apparatus 100>

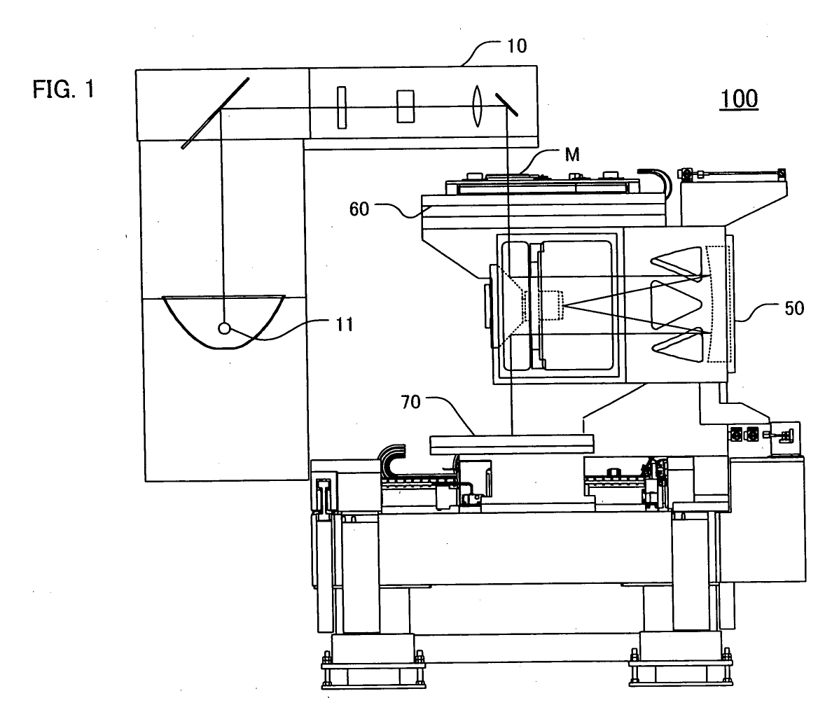

FIG. 1 schematically shows a side surface of a projection exposure apparatus 100.

Referring to this drawing, the projection exposure apparatus 100 mainly includes a light source 11 for emitting light of a spectrum range covering the ultra-violet rays, an illumination optical system 10 for condensing the light from the light source 11, a photo-mask stage 60 for holding a photo-mask M, a catoptric projection system 50, and a substrate stage 70 for holding a substrate.

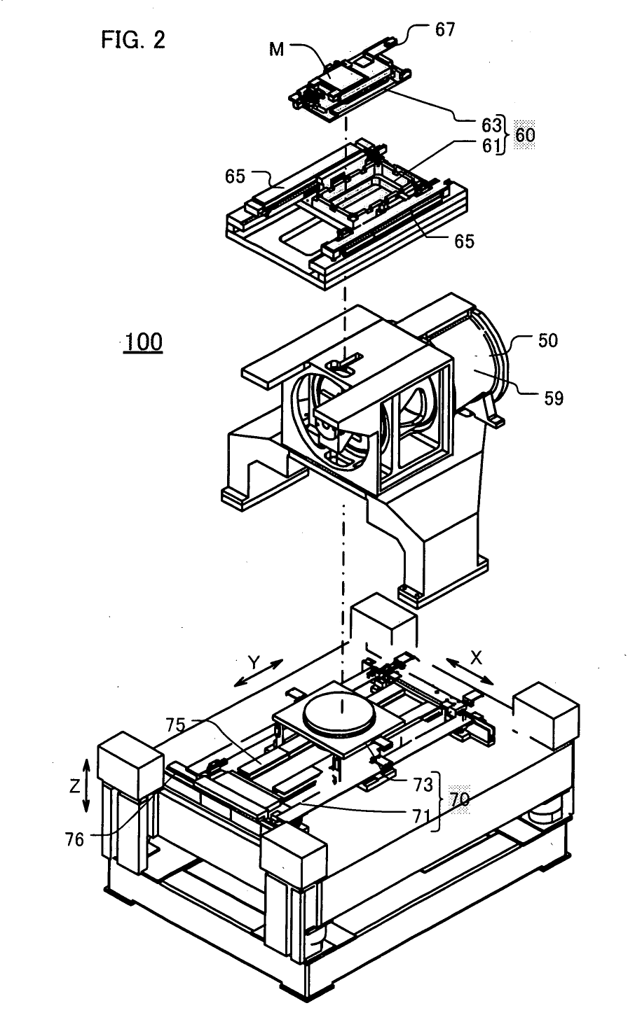

FIG. 2 schematically shows the projection exposure apparatus 100 with the illumination optical system 10 excluded. Specifically, it shows the photo-mask stage 60, the catoptric projection system 50, and the substrate stage 70 with being separated from one another.

The photo-mask stage 60 includes a Y-axis stage 61 for moving the photo-mask M on the Y axis, that is, in a direction where the photo-mask M is to be scanned. This Y-axis stage 61 has a long stroke and employs the step-and-scan type exposure system. The Y-axis stage 61 is driven fast and precisely by linear motors 65 arranged on both sides. In addition, the Y-axis stage 61 has an XT stage 63 that moves on the X-axis and rotates around the Z-axis. This XT stage 63 is driven by a ball screw and a drive motor. Furthermore, the XT stage 63 includes a movable mirror 67 and a laser interferometer (not shown). The XT stage 63 is adapted to change its height.

The catoptric projection system 50 employs the Offner type. This Offner catoptric projection system 50 includes a barrel 59, plane mirrors M1 and M4, and a concave mirror M2 and a convex mirror M3.

The substrate stage 70 has a table on which a substrate, including a semiconductor substrate for a silicon wafer, an electric circuit substrate for a printed circuit board, a glass substrate for a liquid crystal element and a glass element substrate for a PDP, is to be set. The substrate stage 70 includes a Y-stage 71 and an X-stage 73. The Y-stage 71 has a long stroke and moves a substrate on the Y axis, that is, in a direction where the photo-mask M is to be scanned. The X-stage 73 moves a substrate on the X axis, that is, in a direction perpendicular to the scanning direction. The position coordinates of the substrate stage 70 are measured and controlled by the laser interferometer (not shown) using a movable mirror. The substrate stage 70 is adapted to change its height, similar to the photo-mask stage 60. The Y-stage 71 and the X-stage 73 are driven fast and precisely by linear motors 75 and 76 arranged on both sides, respectively.

### <Illumination Optical System>

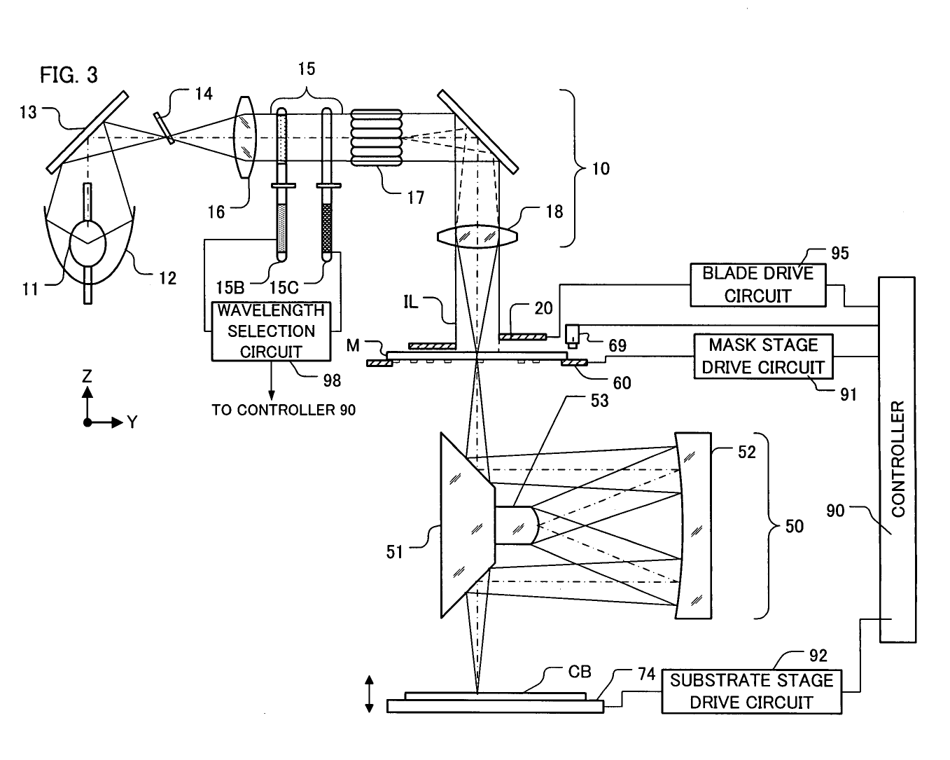

FIG. 3 mainly shows a block diagram of the illumination optical system 10 and a drive control section of the projection exposure apparatus 100.

The projection exposure apparatus 100 includes an illumination optical system 10 for uniformly irradiating, with light, the photo-mask M mounted on the photo-mask stage 60 in parallel with the X-Y plane. The illumination optical system 10 includes a light source 11 composed of a point light source such as the mercury short arc lamp. Since the light source 11 is located at a primary focal point of an elliptic mirror 12, light outputted from the light source 11 forms a light image on the secondary focal point of an elliptic mirror 12 through a dichroic mirror 13. The dichroic mirror 13 is configured to cut off all light components other than those of a spectral range covering the g, h, i and j-lines. In other words, the dichroic mirror 13 filters out light components with a spectrum range of 300 nm or shorter and 460 nm or longer. The light path from both the light source 11 and the elliptic mirror 12 extends upward. However, the present invention is not limited to this configuration. Alternatively, the light path may extend downward.

A shutter 14 is placed at the secondary focal point of the elliptic mirror 12. This shutter 14 is adapted to block the exposure light that transmits toward a substrate CB. The light diverged from the light image that has been formed by the light source 11 is converted into a collimated light ray by a collimated lens 16, and the collimated light ray is then incident to a wavelength selector 15. This wavelength selector 15 is placed across the path of the light ray between the light source 11 and the photo-mask M in a removal fashion.

The light ray from the wavelength selector 15 passes through a fly-eye lens 17 and a condenser lens 18 in this order.

As shown in FIG. 3, the light ray that has passed through the wavelength selector 15 is incident to the fly-eye lens 17. The fly-eye lens 17 is composed of multiple positive lens elements arrayed closely and laterally, while their individual center lines extend parallel to the optical axis of the fly-eye lens 17. The light ray entering the fly-eye lens 17 is subjected to the wavefront splitting by the lens elements. Thus, the fly-eye lens 17 forms multiple secondary light sources at its rear focal points or close to its rear surface. In this case, the secondary light sources are as many as the lens elements of the fly-eye lens 17. In other words, a substantial surface light source is formed at the rear focal points.

The light rays from the secondary light sources formed at the rear focal point are incident to the condenser lens 18. The light rays that have passed through the condenser lens 18 are irradiated to the photo-mask M having patterns thereon. Note that the light source 11 in the illumination optical system 10 may be composed of an ultraviolet LED, an ultraviolet LD or a combination thereof.

Between the condenser lens 18 and the photo-mask M, a masking blade 20 is located. This masking blade 20 functions as a member for light-shielding the photo-mask M. The masking blade 20, which is composed of multiple blades, limits the irradiated area of the photo-mask M and is operated by a blade drive circuit 95.

### <Light Source>

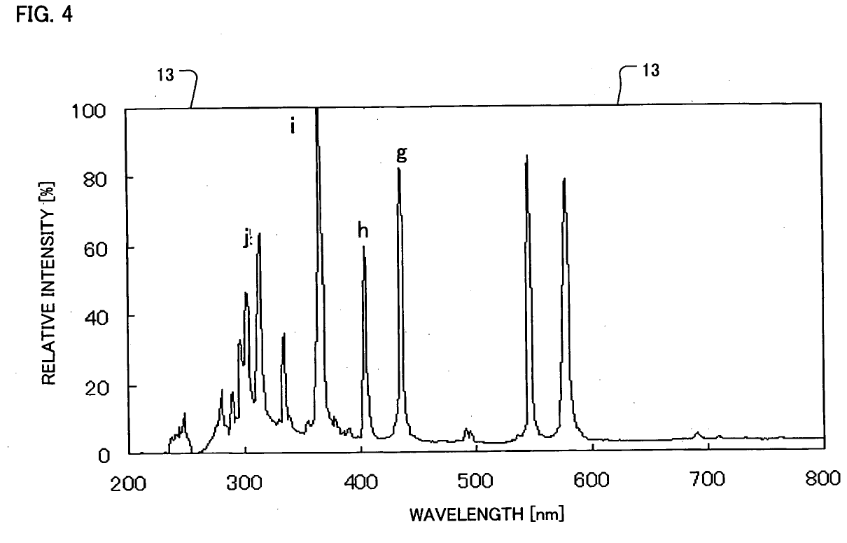

FIG. 4 is a graph showing a relationship between wavelength and light intensity of the mercury short arc lamp used as the light source 11. Its horizontal axis indicates wavelength, and its vertical axis indicates relative light intensity that is normalized by the intensity at the i-line.

This mercury short lamp irradiates enough energy to expose photo-resist layer of the substrate CB. Referring to FIG. 4, the spectral of light from the mercury short arc lamp covers the g, h, i and j-lines. As described above, the dichroic mirror 13 cuts off light components of spectral ranges defined by sloped lines, that is, of the spectral range of 300 nm or shorter and 460 nm or longer.

<Wavelength selector>

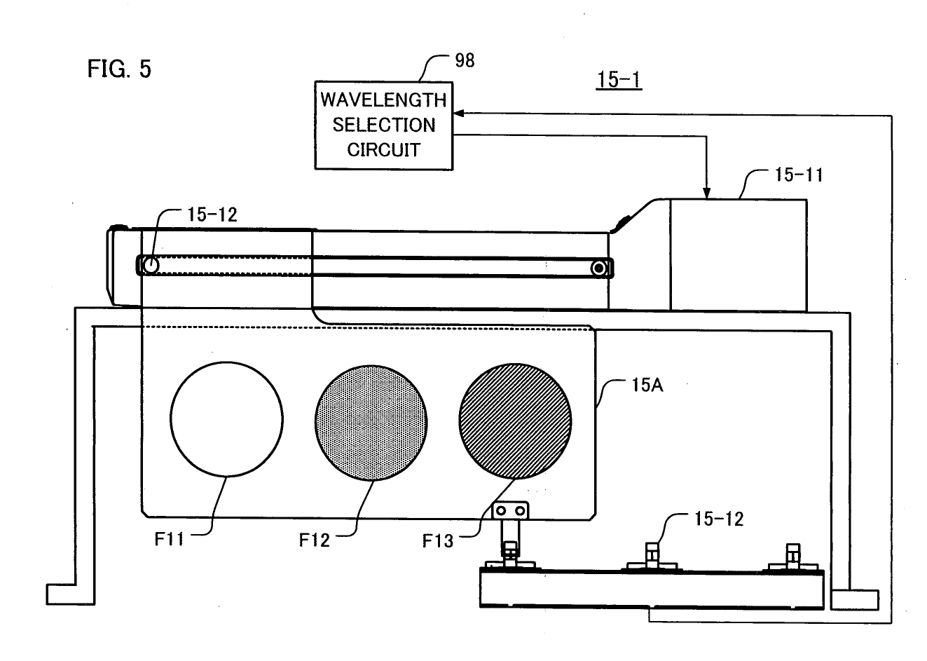

FIG. 5 shows a linear wavelength selector 15-1. This selector 15-1 includes a combination of three optical filters in order to extract light components of a predetermined spectral range from light containing the g, h, i and j-lines.

The linear wavelength selector 15-1 includes a linear slide unit 15A, a driving motor 15-11 and a slide unit 15-12. This linear slide unit 15A is constituted of filters F11 to F13. The driving motor 15-11 linearly slides the slide unit 15-12 coupled to a ball screw. The slide unit 15-12 is coupled to the linear slide unit 15A. This linear slide unit 15A is an object to be sensed by a sensor 15-13. While the linear slide unit 15A is moving at a high speed, once the sensor 19 senses the part of the linear slide unit 15A, the driving motor 15-11 stops its rotation. This is how, respective filters can stop at preset locations.

A filter F11 of the linear slide unit 15A passes all light components therethrough. The filter F12 passes therethrough light components of a spectral range covering the g to i-lines. The filter F13 passes therethrough light components of a spectral range covering the h to j-lines. It is preferable that the above filters can be exchanged in accordance with the property of photo-resist, so that light of desired wavelength is selected.

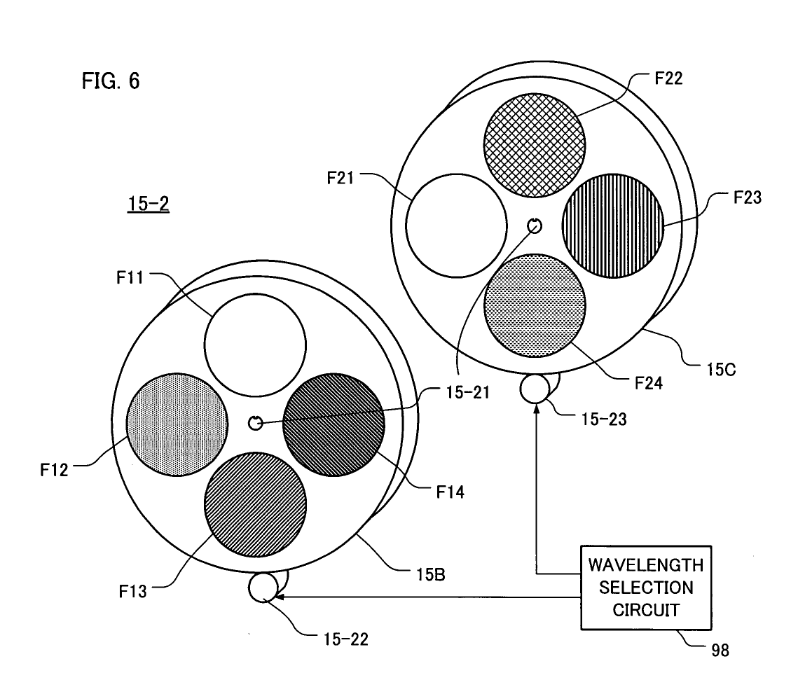

FIG. 6 shows a rotation type wavelength selector 15-2. This selector 15-2 includes a combination of optical filters in order to extract light components of a predetermined spectrum range from light containing the g, h, i and j-lines.

The rotation type wavelength selector 15-2 is constituted of a first wavelength selector 15B and a second wavelength selector 15C. Both selectors are placed on a pupil conjugate plane of the catoptric projection system 50 or on a conjugate plane of the mask, while being aligned on the optical axis of the selector 15-2. To give an example, the first wavelength selector 15B has four filters F11 to F14 and the second wavelength selector 15C has four filters F21 to F24. Once the driving motors 15-22 and 15-23 rotate, the first and second wavelength selectors 15B and 15C rotate around an axis 15-21. The driving motors 15-22 and 15-23 rotate in response to instructions from a wavelength selection circuit 98. The number of filters (F) in each selector is preferably 2 to 5.

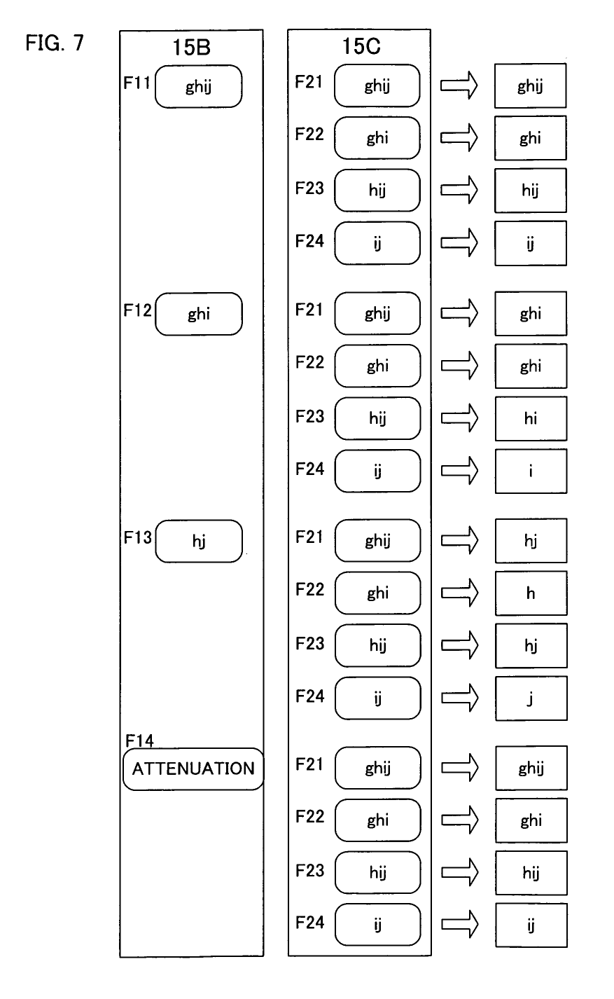

FIG. 7 shows an example of a combination of one of the filters F11 to F14 and one of the filters F21 to F24.

By using the first and second wavelength selectors 15B and 15C in combination, the spectral lines that are shown on the right portion of this drawing can be selected. The filter F11 of the first wavelength selector 15B passes all light components therethrough. The filters F12 and F13 pass through light components of a spectral range covering the g and i-lines and the h and j-lines, respectively. The filter F14 is a neutral density (ND) filter to attenuate light that passes it through.

The filter F21 of the second wavelength selector 15C passes all light components therethrough. The filters F22, F23 and F24 pass through light components of a spectrum range covering the g and i-lines, the h and j-lines, and the i and j-lines, respectively.

By using the filters F11 to F14 of the first wavelength selector 15B and the filters F21 to F24 of the second wavelength selector 15C in combination, light components of a desired spectral range and power can be selected. For example, if the filters F11 and F21, the combination of which are described at the top of FIG. 7, are used, then all light components pass through them. If the filters F12 and F24 are used, then the i-line passes through them. If the filters F13 and F22 are used, then the h-line passes through them. By selecting anyone from among the filters F11 to F14 and anyone from among the filters F21 to F24, the second wavelength selector 15C can provide light of a spectral range in accordance with various applications.

### <Photo-Mask and Projected Image>

The photo-mask M has a surface on which patterns are formed by means of chromium-layer, and it is supported by the photo-mask stage 60. The mask stage drive circuit 91 can move the photo-mask stage 60 in the desired direction. Furthermore, a CCD camera 69, which constitutes a part of a mark detector, is placed over the photo-mask stage 60.

The photo-mask M is irradiated with the exposure light, and the light ray that passes through the photo-mask M propagates toward the Offner catoptric projection system 50. When entering the system 50, the light ray is guided into the barrel 59 of the system 50 by the plane mirror M1, and the guided ray is then reflected by the concave mirror M2 and the convex mirror M3 in this order. Then, the reflected ray returns to the concave mirror M2. Subsequently, the light ray is reflected by the concave mirror M2 and the plane mirror M4 in this order, and is then outputted from the system 50. Finally, the light ray reaches the substrate CB.

The Offner catoptric projection system 50 transfers patterns of the photo-mask M to the surface of the substrate CB. Further, the transferred patterns are reverse of that formed on the photo-mask M. The Offner catoptric projection system 50 has an optical magnification of 1:1. This projection system 50 does not cause chromatic aberration, because it is composed only of the several plane mirrors. In this embodiment, the exposure light is ultraviolet light containing the g, h, i and j-lines. Thus, the spectral range of the exposure light exceeds 100 nm. In this case, it is extremely difficult for a projection system composed of lenses to correct the chromatic aberration of the light. However, this Offner catoptric projection system 50 has no chromatic aberration. In other words, the system 50 can focus the exposure light containing the g and j lines on the surface of the substrate CB with precision.

The substrate table 74 has chucks for vacuum attraction of the substrate CB, and a substrate stage drive circuit 92 moves the substrate CB in the X, Y, Z and T directions. A focal point sensor (not shown) detects the focal point of the light from the catoptric projection system 50, and the substrate stage drive circuit 92 moves the substrate CB on the Z axis based on the detected result. In this way, the light projected from the Offner catoptric projection system 50 is focused on the surface of the substrate CB. In other words, the image of the patterns on the photo-mask M is formed on the surface of the substrate CB. Following this, the photo-resist applied to the surface of the substrate CB reacts with the light. As a result of this reaction, the patterns of the photo-mask M are transferred to the surface of the substrate CB.

The controller 90 allows the mask stage drive circuit 91 and the substrate stage drive circuit 92 to drive the photo-mask stage 60 and the substrate stage 70, respectively. In addition, this mechanism employs the first system “step-and-repeat system” or the second system “step-and-scan system.” The step-and-scan system is to move the photo-mask M and the substrate CB in sync with each other while the speed of one of them is adjusted. Consequently, the expansion and contraction of the photo-mask M on the Y axis is adjusted. An exposure selector of the controller 90 can switch the step-and-repeat system and the step-and-scan system in response to setting of an operator.

### <Photo-Mask M>

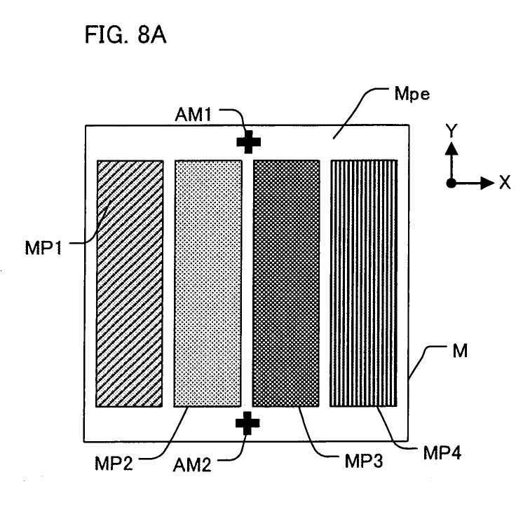

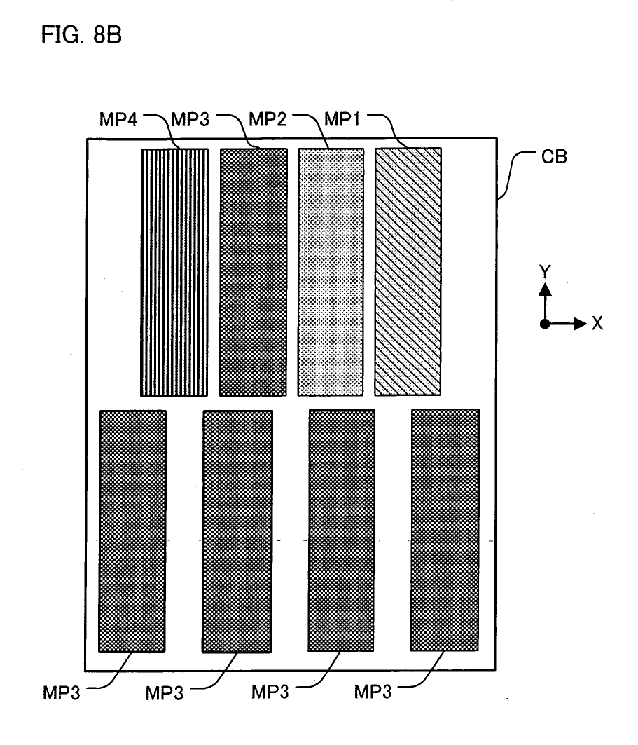

FIGS. 8A and 8B show the photo-mask M and the substrate CB that has undergone the exposure process, respectively.

FIG. 8A shows the photo-mask M as seen from the top. The photo-mask M has the frame made of a plate-shaped silica glass member, and this frame is parallel to the X or Y axis. On the central area of the photo-mask M, pattern sections MP1 to MP4 are formed. These sections are wire patterns made of, for example, chromium. Near the edges of the photo-mask M, a pattern section Mpe on which no wire patterns are formed is defined.

On two portions at the center of the pattern section Mpe on the X axis, the alignment marks AM1 and AM2 (for example, of a cross shape) are formed. The alignment marks AM1 and AM2 are used to measure the position coordinates and inclination T of the photo-mask M. In this embodiment, both the alignment marks AM1 and AM2 have a cross shape, but the present invention is not limited to this configuration. Alternatively, the marks may be of any given shape as long as its location and dimension are recognized beforehand.

### <Substrate CB>

FIG. 8B shows the substrate CB as seen from the top. The patterns are to be transferred to the center of the substrate CB. Referring to the upper half area of the substrate CB of FIG. 8B, the pattern sections MP1 to MP4 are formed on the substrate CB by employing the step-and-repeat system and the optical magnification of 1:1. Meanwhile, its lower half area, the four pattern sections MP3 are formed on the substrate CB on the same condition. Moreover, the masking blade 20 (as will be described later) blinds the predetermined region on the photo-mask M, whereby desired patterns are formed thereon.

### <Alignment of Photo-Mask>

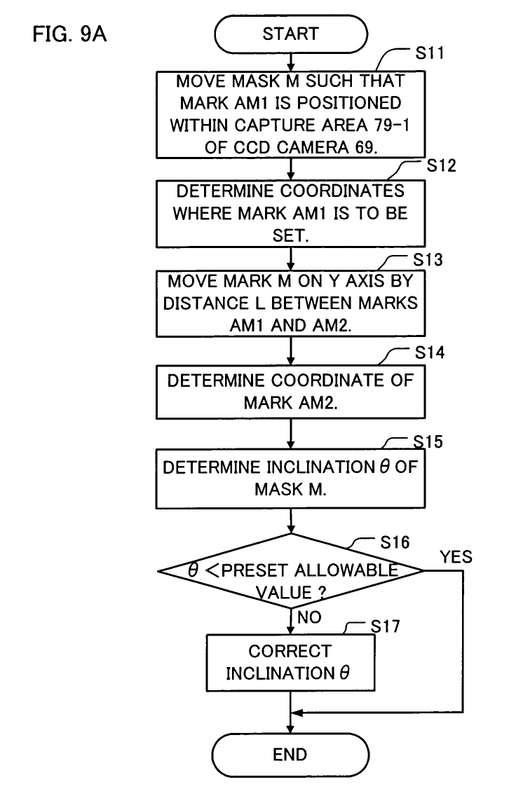

FIG. 9A shows a flow of a process for aligning the photo-mask M, and FIG. 9B shows the movement of the photo-mask M during the process. The mark sensor includes the CCD camera 69 and a lamp (not shown), and the spectrum range of the light from the lamp is selected so as not to react with the photo-resist coated on substrate CB.

At the step S11 of FIG. 9A, the controller 90 moves the XT stage 63 by using the mask stage drive circuit 91 such that the mark AM1 of the photo-mask M is positioned within a capture area 69-1 of the CCD camera 69 (see FIG. 3).

At the step S12, the lamp (not shown) irradiates an area covering the alignment mark AM1, while the CCD camera 69 captures the image of the alignment mark AM1. The controller 90 determines the positional data (X and Y coordinates) on a location where the alignment mark AM1 is to be set, based on the captured image (see upper drawing of FIG. 9B).

At the step S13, the controller 90 moves the XT stage 63 on the Y axis by a distance L. This distance L is equal to a distance between the alignment marks AM1 and AM2. When the XT stage 63 is moved on the Y axis by the distance L, the alignment mark AM1 should be positioned where the mark AM2 was located before the movement, unless the photo-mask M is inclined (see FIG. 9B).

At the step S14, the CCD camera 69 captures the image of the alignment mark AM2. The X and Y coordinates of the alignment mark AM2 are determined based on the captured data.

At the step S15, a position computing unit of the controller 90 determines the inclination T of the photo-mask M. This inclination T can be determined based on the X and Y coordinates of the alignment marks AM1 and AM2 and the distance L.

At the step S16, the controller 90 determines whether or not the inclination T is equal to/less than a preset allowable value. If the inclination T is determined to exceed the preset allowable value (“No” at the step S16), then the process proceeds to the step S17, and the X Tstage 63 is angled to correct the inclination T of the photo-mask M. Otherwise (“Yes” at the step S16), the process terminates.

### <Mask Shielding Member>

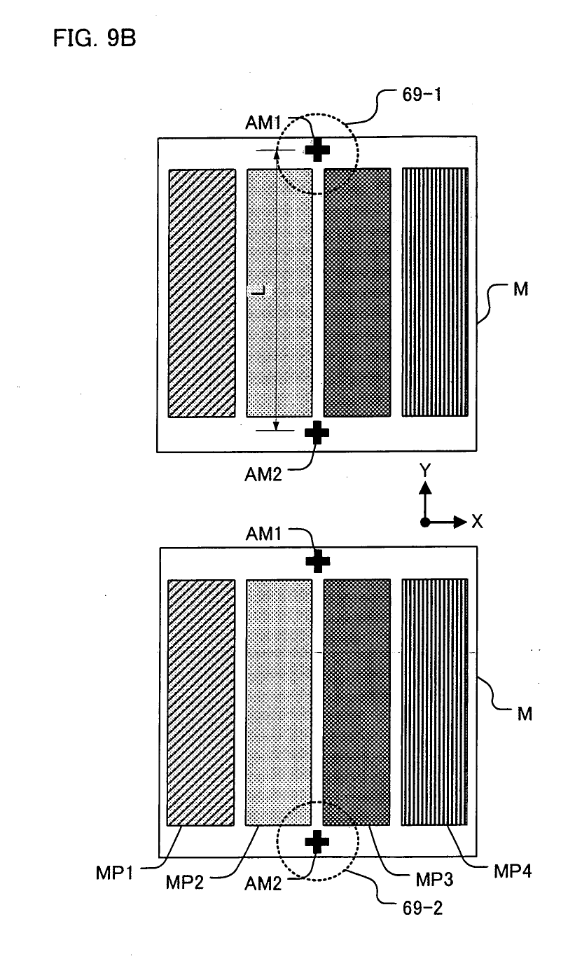

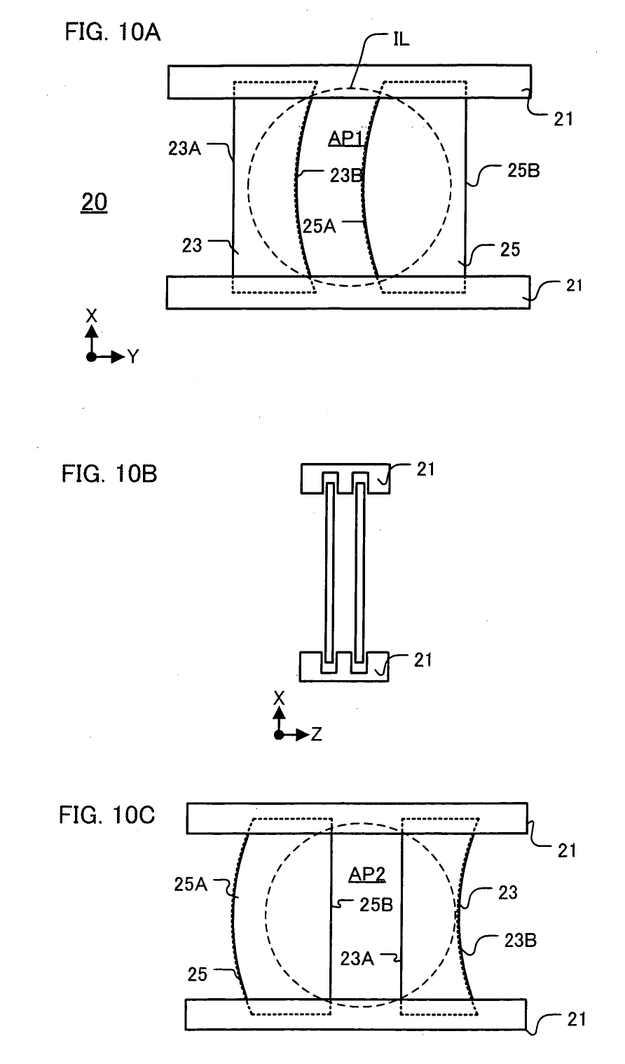

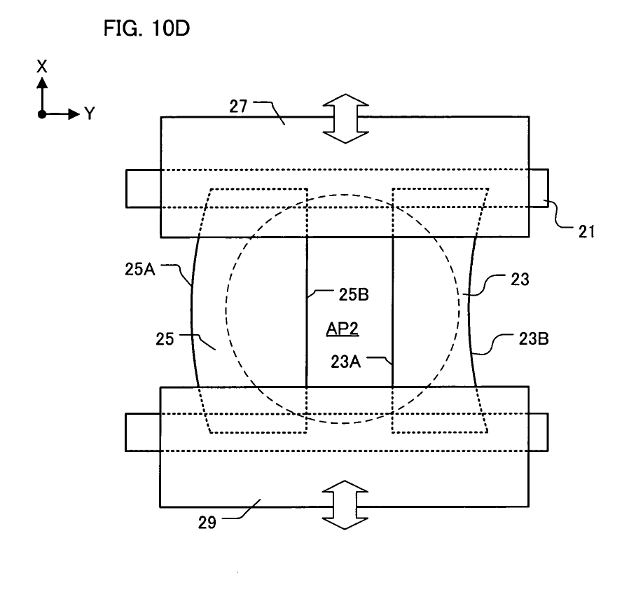

FIGS. 10A to 10D show the masking blade 20. FIG. 10A shows the mask shielding member. Note that in this drawing, a third blade 27 and a fourth blade 29 that are movable on the X axis are removed. FIG. 10D shows the mask shielding member including the third blade 27 and the fourth blade 29.

Referring to FIG. 10A, the masking blade 20 includes guide rails 21, a first blade 23 and a second blade 25. The first and second blades 23 and 25 can be moved on the Y axis and along the guide rails 21 by the blade driving circuit 95 (see FIG. 2) and a driving motor (not shown). The first and second blades 23 and 25 are arranged away from each other on the Z axis as shown in FIG. 10B, so that they do not interfere with one another. In the first blade 23 of FIG. 10A, the left edge 23A is formed extending linearly on the X axis, while the right edge 23B is formed in the incurved shape. In the second blade 25 of FIG. 10A, the left edge 25A is formed in the outcurved shape, while the right edge 25B is formed in the linear shape and extending on the X axis.

Referring to FIG. 10A, a space AP defined by the right edge 23B of the first blade 23 and the left edge 25A of the second blade 25 has curved lines. The region where the Offner catoptric projection system 50 hardly causes aberration has a curved shape. Hence, the shape of the space AP1 accords with that of the above region. It is preferable that the exposure process is conducted while the exposure light passes the space AP1, especially when catoptric projection system 50 employs the step-and-scan system.

When the first and second blades 23 and 25 move on the Y axis and exchange their positions, a space AP2 as shown in FIG. 10C is defined. The space AP2 defined by the left edge 23A of the first blade 23 and the right edge 25B of the second blade 25 forms a rectangle shape. Typically, many wire patterns formed on the photo-mask M are rectangular. Especially, when the patterns are transferred sequentially by employing the step-and-repeat system, the exposure process is conducted through the space AP2. To give an example, the pattern sections MP1 to MP4 on the upper area of the substrate CB of FIG. 8B are formed by transferring the pattern sections MP1 to MP4 of the photo-mask M of FIG. 8A. Note that the transferred patterns are formed in reverse because of the Offner catoptric projection system 50.

Referring to FIG. 10D, the masking blade 20 includes the third blade 27 and the fourth blade 29 that are both movable on the X axis. The third and fourth blade 27 and 29 are arranged apart from each other on the Z axis, so that they do not interfere with one another.

When the pattern section MP3 of the photo-mask M as shown in FIG. 8A are transferred to the surface of the substrate CB multiple times, the controller 90 moves the first blade 23 to the fourth blade 29, so that only the exposure light irradiated to the pattern section MP3 passes through the space AP2. In this case, the step-and-repeat system can be used to transfer the pattern section MP3 only.

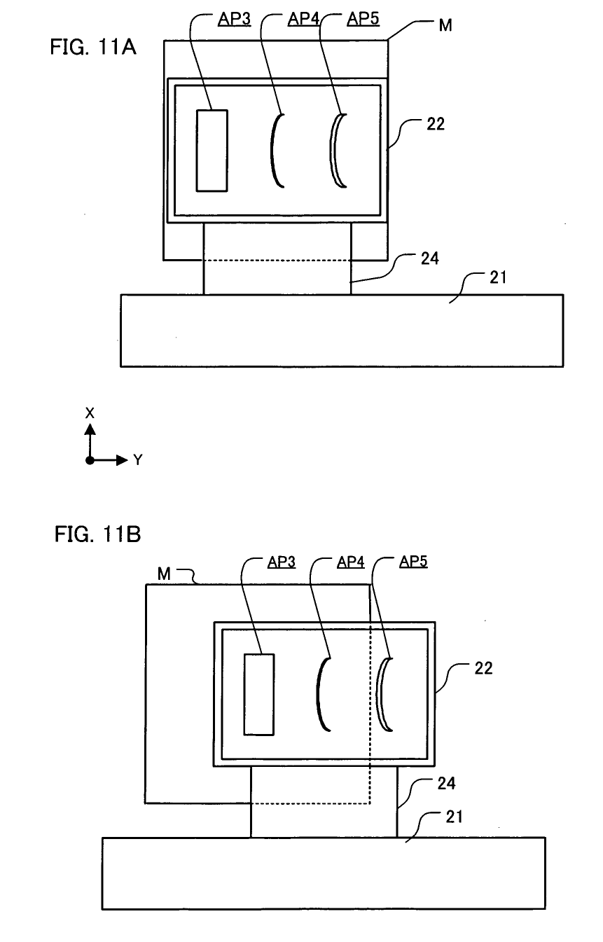

FIGS. 11A and 11B show another masking blade 22. This masking blade 22 includes a rectangular space AP3, a narrow curved space AP4, and a wide curved space AP5. The masking blade 22 is moved on the Y axis by the blade drive circuit 95 (see FIG. 3) and the driving motor (not shown). Moreover, the guide rail 21 is coupled to the masking blade 22 by an arm member 24.

FIG. 11A shows an example of an exposure process carried out by the narrow curved space AP4 by employing the step-and-scan system. The wide curved space APS may be used to carry out the exposure process instead of the space AP4. For example, the space AP4 may be about 3 mm wide and the space APS may be about 7 mm wide. The arc spaces AP4 and AP5 are switched in accordance with the type of the photo-resist or the type of the filter F of the wavelength selector 15.

FIG. 11B shows an example of an alignment process of the photo-mask M by using the rectangular space AP3. In this case, the spaces AP4 and AP5 are fixed at locations shown in this drawing. The CCD camera 69 can capture the images of the alignment marks AM1 and AM2 through the rectangular space AP3.

### <Mechanism and Barrel>

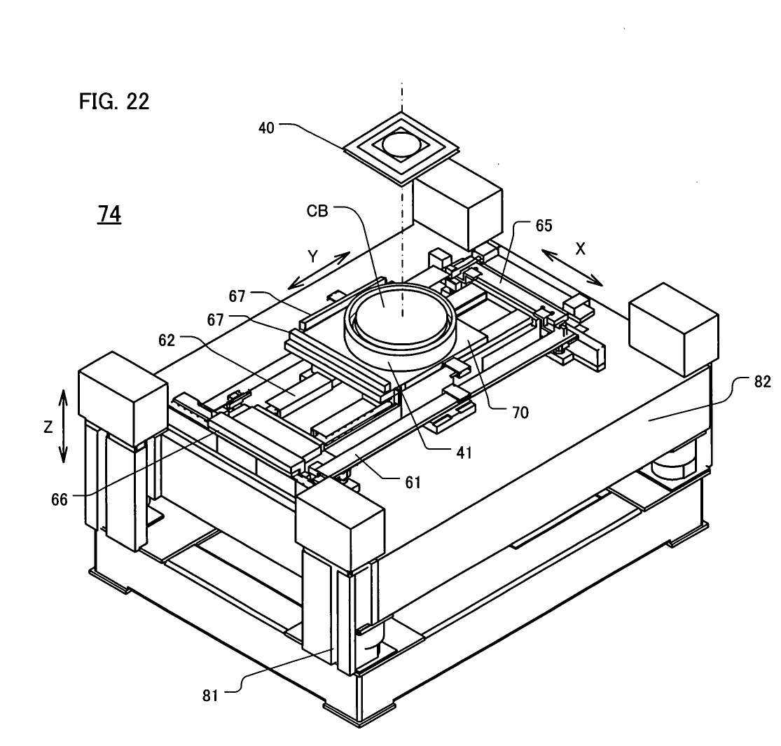

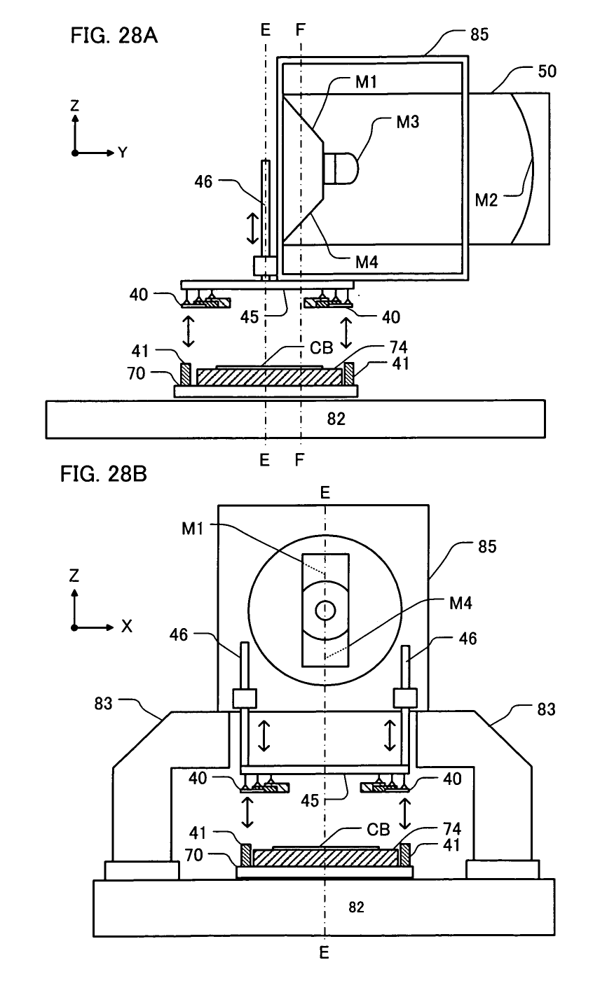

Referring to FIGS. 22 and 28, all the members of the projection exposure apparatus 100 are installed on four vibration isolated mounts 81 for the purpose of improving the accuracy of the exposure process. First, a base 82 made of a stone table, alumina ceramics or metal is placed on the four vibration isolated mounts 81. The substrate stage 70 is mounted on the base 82. A barrel support stage 83 is located on the base 82 in such a way that it does not interfere with the movement of the substrate stage 70. The catoptric projection system 50 is set on the barrel support stage 83. A mask stage support 85 is mounted on the barrel support stage 83. Finally, the photo-mask stage 60 is set on the mask stage support 85.

The catoptric projection system 50 and the mask stage support 85 are attached to each other through their respective flanges. The members of the mask stage support 85 are adapted not to give a Z-axis load and X-Y-axis vibrations to the catoptric projection system 50, although the mask stage support 85 are attached to the catoptric projection system 50. Therefore, vibrations caused by the movement of the Y-axis stage 61 or the XT stage 63 are hardly transmitted to the catoptric projection system 50. In addition, because of the barrel support stage 83 located between the catoptric projection system 50 and the substrate stage 70, the vibrations caused by the movement of the substrate stage 70 is not transmitted directly to the projection system 50. <Structure of Catoptric Projection System 50>

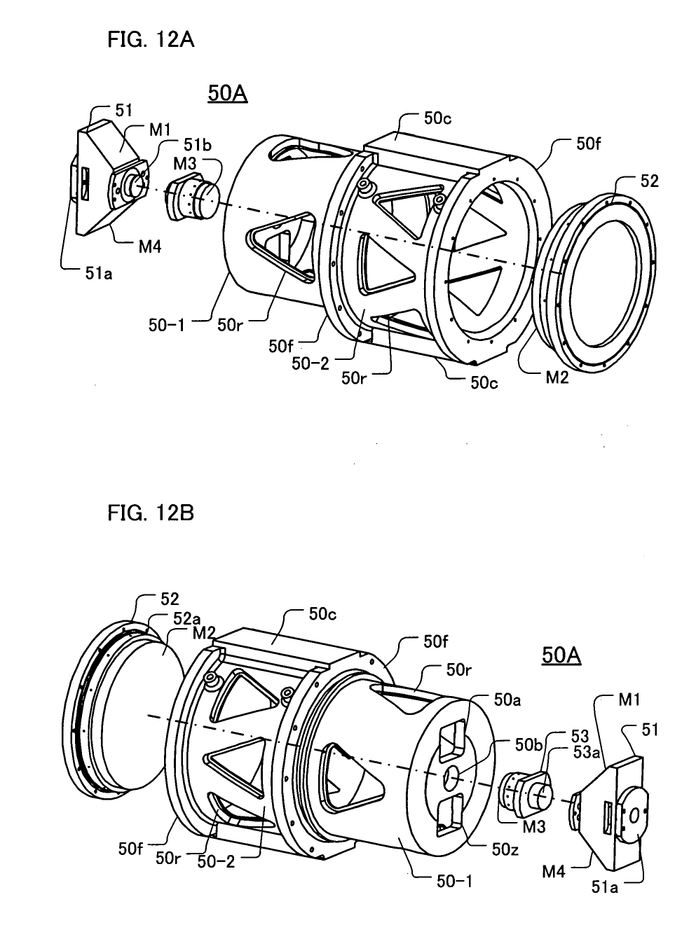

FIGS. 12A and 12B show members constituting the first catoptric projection system 50A. FIG. 12A shows the first catoptric projection system 50A as seen from the side of the concave mirror M2, while FIG. 12B shows the system as seen from the side of the mirror M1. The Offner first catoptric projection system 50A includes a first barrel 50-1 of a small inner diameter and a second barrel 50-2 of a large inner diameter, and both barrels are integrated by a member having low thermal expansion. The first barrel 50-1 includes a plane mirror M1, a convex mirror M3 and a plane mirror M4, while the second barrel 50-2 includes a concave mirror M2.

The catoptric projection system 50 merely has the reflection mirrors and fixed mirrors (not shown) for measurement using the laser interferometer. Thus, it is not coupled to any members that may transmit vibrations.

The first barrel 50-1 includes, at an end surface, an exposure light input opening 50a which the exposure light enters, and an exposure light output opening 50z from which the exposure light outputs. The first barrel 50-1 has, on the end surface, a hole 50b to which a trapezoid mirror support 51 for holding the plane mirrors M1 and M4 and a convex mirror holder 53 for holding the convex mirror M3 are to be attached.

Multiple triangular openings 50r are formed on a circumference of the first barrel 50-1 in order to reduce its weight. The triangular openings 50r are arranged such that stresses do not concentrate on any given place of the first barrel 50-1. Preferably, the inner diameter of the first barrel 50-1 is as small as possible in terms of weight reduction, as long as the barrel 50-1 does not interfere with the light path. With those triangular openings 50r, the fluctuation of the air can be prevented, because the air does not stay inside the barrel for a long time.

The trapezoid mirror support 51 is made of alumina ceramic. The plane mirrors M1 and M4 are formed by subjecting alumina ceramic to mirror finish and by depositing it with aluminum. In this case, the mirrors M1 and M4 are arranged forming a right angle. The trapezoid mirror support 51 is provided with a reference member 51a and a circular projection 51b which both are arranged opposite each other.

The convex mirror holder 53 holds the convex mirror M3. This convex mirror M3 is secured thereto by means of a mechanical way such as using adhesive or a clamping member. The circular projection 51b of the trapezoid mirror support 51 is attached to the mirror-attached hole 50b. Furthermore, the circular projection 53a of the convex mirror holder 53 is attached to the mirror-attached hole 50b from an inner side of the first barrel 50-1. The circular projection 51b keeps in surface contact with the circular projection 53a, whereby the angles and positions-of the mirrors M1 and M4 with respect to the convex mirror M3 are regulated.

The second barrel 50-2 has two flanges 50f on both edges in order to enhance its strength. In addition, the beams 50c support both flanges 50f on the upper and lower sides. Thus, it successfully attains the lightweight and strong property. Multiple triangular openings 50r are formed on the circumference of the second barrel 50-2 in order to reduce its weight. These triangular openings 50r are arranged such that stresses do not concentrate on any given place on the second barrel 50-2. The lower beam 50c is to be fixed to the barrel support stage 83 with, for example, one or more bolts. To the upper beam 50c of the second barrel 50-2, measurement equipment such as the laser interferometer or the fixed mirror for alignment is to be attached.

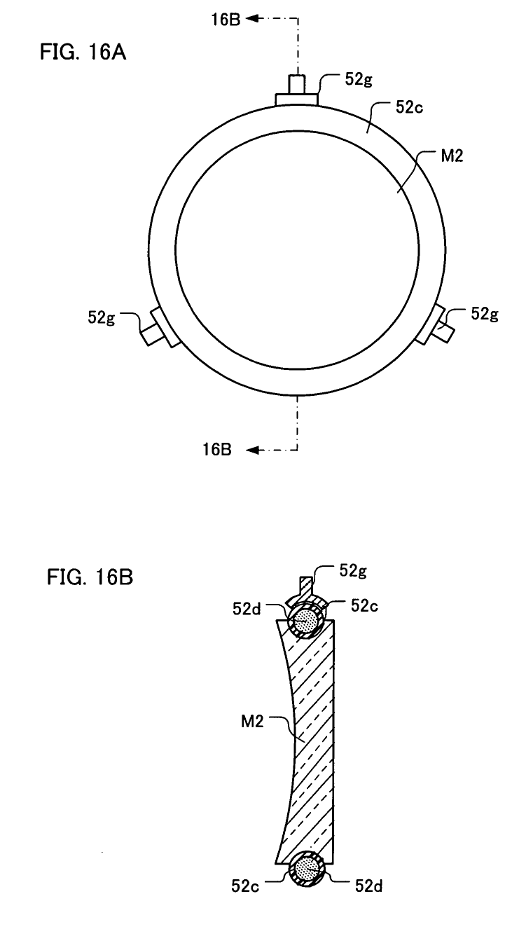

A reference surface 52a of the concave mirror holder 52 is coupled to the edge surface of the second barrel 50-2 with, for example, one or more bolts. The concave mirror holder 52 holds the concave mirror M2 of a large diameter. Upon coupling, the angle and position of the concave mirror M2 with respect to the plane mirrors M1 and M4 can be adjusted. The concave mirror M2 is fixed by means of a mechanical way such as using glue or a clamp material. The coupling of a clamping member will be described later with reference to FIG. 16.

### <Another Catoptric Projection System>

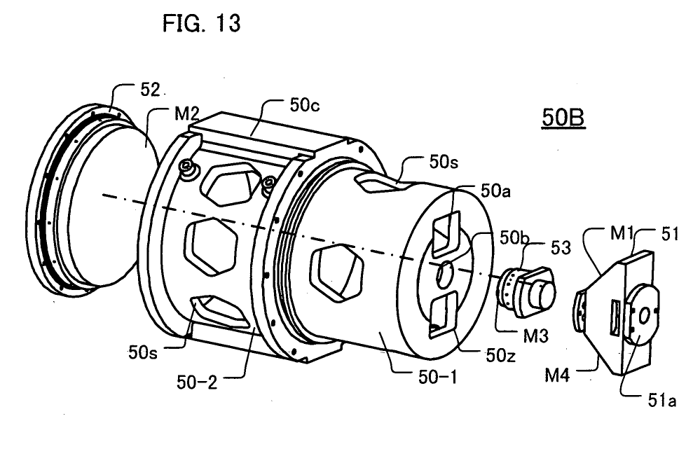

FIG. 13 shows members of a second catoptric projection system 50B with being separated from one another.

In this second catoptric projection system 50B, the circumference of a first barrel 50-1 has multiple hexagonal openings 50s in order to reduce its weight. The hexagonal openings 50s are arranged such that stresses do not concentrate on any given place of the first barrel 50-1. A second barrel 50-2 of the second catoptric projection system 50B also has multiple hexagonal openings 50s on its circumference for the purpose of the weight reduction. The first and second catoptric projection systems 50A and 50B have similar structures except for the shape of the openings (triangle or hexagonal shape).

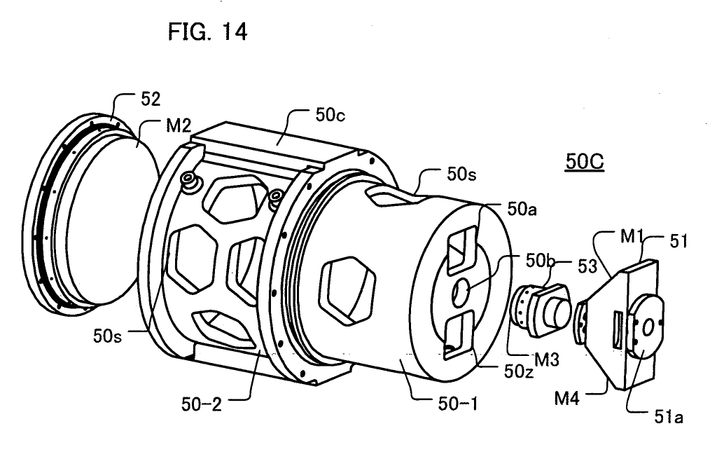

FIG. 14 schematically shows members of a third catoptric projection system 50C with being separated from one another. In this third catoptric projection system 50C, a first barrel 50-1 has multiple hexagonal openings 50s for its weight reduction. A second barrel 50-2 of the third catoptric projection system 50C also has multiple hexagonal openings 50s on its circumference for its weight reduction. Note that the second barrel 50-2 of the third catoptric projection system 50C has more hexagonal openings 50s than that of the second catoptric projection system 50B.

### <Deformation Amount of Catoptric Projection System 50>

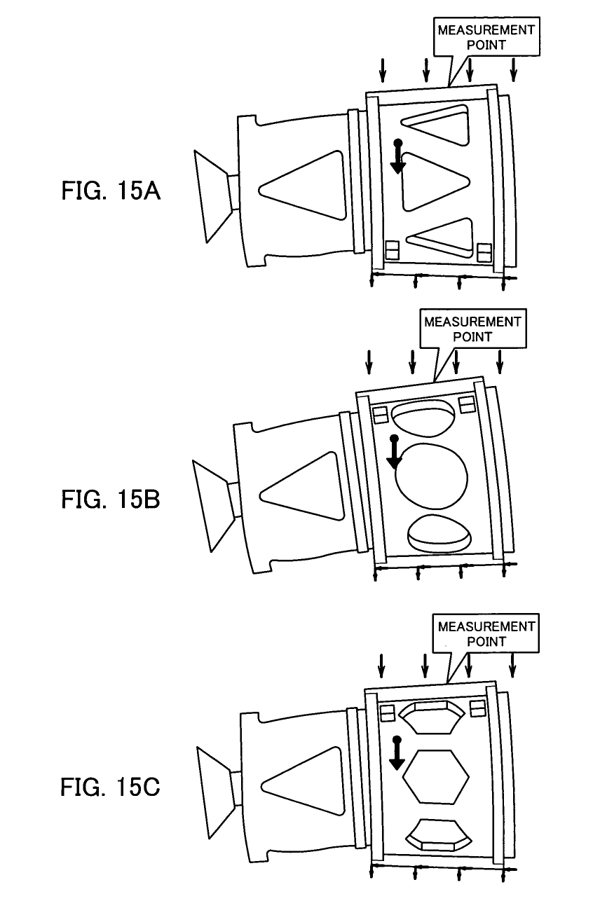

FIGS. 15A to 15C show a result of determining the displacement amount of the catoptric projection system 50 by using the finite element method, on the condition that the lower beam 50c is fixed and the upper beam 50c bears a load of 500N. In FIG. 15A, each of the first and second barrels 50-1 and 50-2 has multiple triangular openings on the circumference. In FIG. 15B, the first barrel 50-1 has multiple triangular openings on the circumference, while the second barrel 50-2 has multiple circular openings. In FIG. 15C, the first barrel 50-1 has multiple triangular openings on the circumference, and the second barrel 50-2 has multiple hexagonal openings. The determination is done on the condition that the total area of the openings of each of FIGS. 15A, 15B and 15C accounts for 40% of the whole surface area.

The displacement amount of the upper beam 50c in the catoptric projection system 50 is computed. In FIG. 15A, the system 50 has the displacement amount of 9.9 Πm. In FIG. 15B, the displacement amount is 100 Πm. In FIG. 15C, the displacement amount is 9.5 Πm. As a result, the second barrel 50-2 of FIG. 15B having the circular openings has ten times as large displacement amount as that of the second barrel 50-2 of FIG. 15A or 15C having the triangular or hexagonal openings. Note that FIGS. 12 and 15A to 15C show the catoptric projection system 50 with the openings of various shapes including triangular and hexagonal shapes.

Next, the displacement amount is determined by using the finite element method on the condition that a ratio of the surface area of the triangular or hexagonal openings to the whole surface area of the first and second barrels 50-1 and 50-2 is varied from 20% to 50%. This result proves the determined displacement amount is equal to/less than 10 Πm even on this condition.

The respective total surface areas of the openings of FIGS. 15A to 15C are substantially the same. Therefore, air flows in substantially the same fashion inside the barrel. In other words, although any of the openings reduces the fluctuation of the air, their displacement amounts are different. Thus, the appropriate shape of the openings can be triangular (FIG. 15A) or hexagonal (FIG. 15C) in terms of the rigidity.

### <Fixture of Concave Mirror M2>

FIG. 16A shows the concave mirror M2 held by a ring 52c, and FIG. 16B shows a cross-section of the concave mirror M2 taken along a line B-B of FIG. 16A.

On the circumference of the concave mirror M2, the hollow elastic ring 52c is provided. Non-flowing fluid 52d is filled in the elastic ring 52c. An example of the fluid 52d includes liquid such as water or alcohol and gas such as argon, helium or nitrogen. Clamp materials 52g made of stainless steel or invar are arranged at regular intervals at three points on the outer circumference of the elastic ring 52c. The concave mirror M2 is fixed in a vertical position by these clamp materials 52g.

Since the concave mirror M2 is the largest in the four plane mirrors, it may be highly sensitive to the deformation of the barrel. However, even when the circumference of the elastic ring 52c is deformed non-uniformly, the elastic ring 52c keeps supporting the circumference of the concave mirror M2 at a substantially regular force due to the buffering effect of the fluid 52d. Moreover, when the concave mirror M2 is supported by the first and second barrels 50-1 and 50-2 having the triangular or hexagonal openings, it is more likely to resist the deformation due to the load.

### <Light-Shielding of Rim of Substrate>

The projection exposure apparatus 100 is equipped with a light-shielding body for partially blinding the substrate. With this light-shielding body, the exposure light is not irradiated to the rim of the substrate to which negative type photo-resist is applied.

### First Embodiment: Case Where Rotatable Light-Shielding Body is Used

The substrate table 74 has a guide rail 31 for setting the light-shielding body. A first light-shielding body positioning portion 32 having a fan-shaped first light-shielding body 30 moves above the rim of the substrate CB. As a result, a blind zone 39 to which no patterns are transferred is formed on the rim of the substrate.

While the light is irradiated to the first light-shielding body 30, the body 30 is being heated. When the first light-shielding body 30 is heated, it may be deformed to thereby blind not only blind zone 39 but also another region of the exposure area EA. In consideration of this, it is preferable that the first light-shielding body 30 is made of heatproof-coated titanium alloy, invar alloy of Fe-36Ni having a low thermal expansion coefficient, kovar alloy of Fe29Ni-17Co, or ceramic.

When a negative type photo-resist is applied to the surface of the substrate, the non-irradiated portion (blind zone 39) of the resist is removed during the development process. Accordingly, the portion of the photo-resist does not come off the substrate to become contaminants. On the region where the photo-resist is removed, the underneath layer is exposed. If this exposed layer is a conductive film, then it can be used as an electrode during a plating process.

A description will be given blow, of a structure and an operation of the first light-shielding body positioning portion 32 and the first light-shielding body for forming the blind zone 39.

### EXAMPLE 1

### Retractable Light-Shielding Body

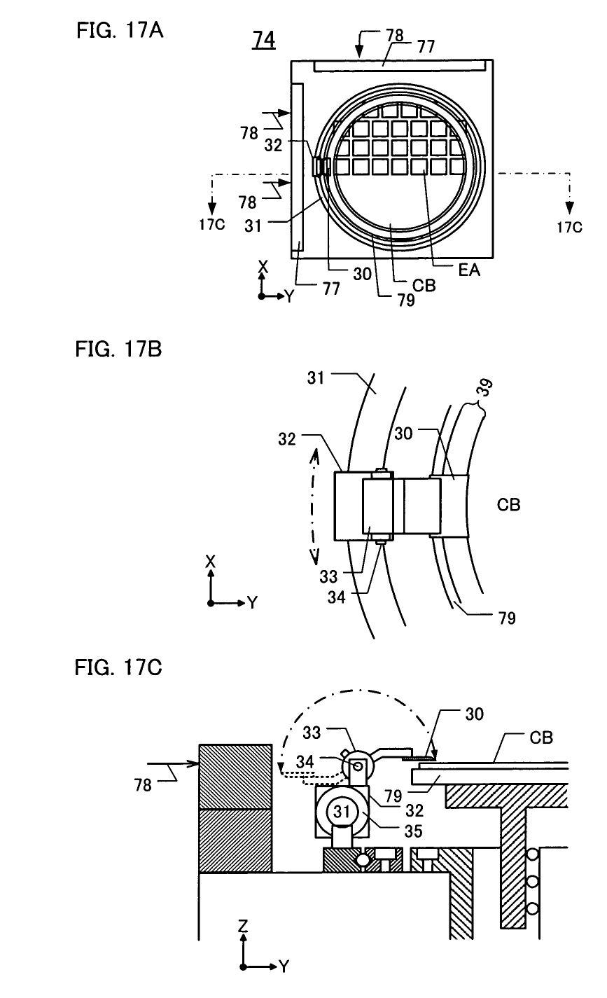

FIG. 17A shows the substrate table 74 of FIG. 2 as seen from the top.

Referring to this drawing, the substrate CB is held on the substrate table 74, and a ring-shape guide rail 31 is set around the rim of the substrate CB. The guide rail 31 is provided with the first light-shielding body positioning portion 32, and this portioning portion 32 can move around the rim of the substrate CB freely. In other words, the first light-shielding body positioning portion 32 can slide on the guide rail 31 at 360 degree. As the exposure location is approaching the rim of substrate CB, the position of the first light-shielding body 30 is determined based on the coordinate information of the substrate table 74. Therefore, the first light-shielding body 30 can be held at a predetermined location.

The substrate table 74 is equipped with moving mirrors 77 arranged on the X and Y sides, respectively. The combination of the moving mirrors and the laser interferometer enables the position of the substrate table 74 to be controlled precisely. Laser beams 78 from the laser interferometer are directed on the X and Y axes, and reach two sides of the substrate. The reason why two laser beams run in parallel to the Y axis is to control the rotational position around the Z axis.

FIG. 17B shows an enlarged surrounding area of the first light-shielding body positioning portion 32. This positioning portion 32 includes the first light-shielding body 30, a rotary cylinder 33, a linear motor 35 and a pole for supporting the above.

FIG. 17C shows a vertical cross-section of the first light-shielding body positioning portion 32 of FIG. 17B.

The rotary cylinder 33 rotates around a rotational axis 34 at 180 degree, and the first light-shielding body 30 partially covers the substrate CB on the substrate table 74, that is, partially blind it. Upon exchange of the substrate CB for another, the first light-shielding body 30 is simply moved to an escape location indicated by a dotted line. This makes it possible to exchange substrates promptly without risking-any damage.

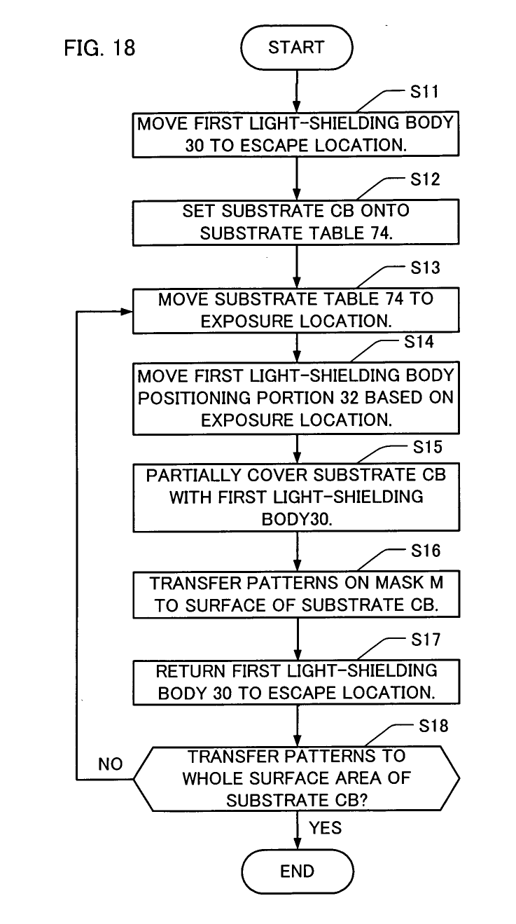

FIG. 18 shows a first flow of the exposure process executed on the substrate table 74.

At a step S11, the rotary cylinder 33 rotates the first light-shielding body 30 of the first light-shielding body positioning portion 32. Then, the first light-shielding body 30 is moved to the escape location, that is, an initial location. In this example, the first light-shielding body 30 is moved by the rotary cylinder 33. However, the present invention is not limited to this configuration. Alternatively, another mechanism may be employed.

At a step S12, the substrate stage drive circuit 92 moves the substrate table 74 to an exchange location for the substrate CB. Then, a substrate transport mechanism (not shown) sets the substrate CB onto the center of the substrate table 74. Following this, the vacuum chuck 79 starts holding the substrate CB.

At a step S13, the Y-stage 71 and the X-stage 73 move the substrate table 74 to the exposure location. The position of the substrate table 74 is controlled precisely by the laser interferometer.

At a step S14, the controller 90 moves the first light-shielding body positioning portion 32 on the guide rail 31, based on the exposure location. Then, the first light-shielding body 30 stands by at the escape location near the exposure location.

At a step S15, the rotary cylinder 33 rotates the first light-shielding body 30, so that the body 30 partially covers the substrate CB.

At a step S16, the catoptric projection system 50 transfers the patterns of the photo-mask M to the photo-resist applied to the surface of the substrate CB. The first light-shielding body 30 defines the blind zone 39 on which no patterns are formed.

At a step S17, after one exposure area EA has been formed, the controller 90 returns the first light-shielding body 30 to the escape location in order for the body 30 to move to a next exposure area EA.

At a step S18, the controller 90 determines whether or not the catoptric projection system 50 has transferred the patterns of the photo-mask M to the whole surface area of the substrate CB. If the patterns are not yet transferred to the whole surface area (“No” at the step S18), then the process proceeds to the step S13. The above-described exposure process repeats. Otherwise, if the patterns have been fully transferred (“Yes” at the step S18), then the process proceeds to a finish process of the step S18. After the process is subjected to all the exposure areas EA, the blind zone 39 without patterns is defined on the rim of the negative-photo-resist-coated substrate by the first light-shielding body 30.

Since the first light-shielding body 30 is moved between blinding and escape locations for a short time, the substrate CB can be removed promptly without risking any damage. Now, the projection exposure apparatus 100 is ready to receive a new substrate CB onto the substrate table 74. The exposure process can proceed to the step S12 quickly, which results in the prompt process.

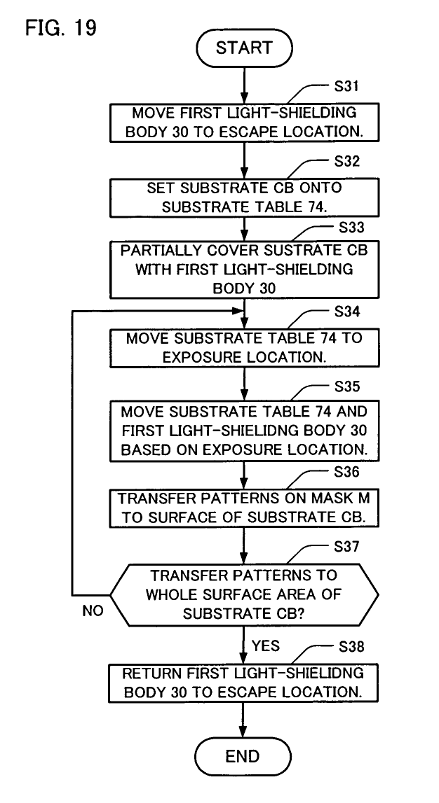

FIG. 19 shows a second flow of the exposure process executed on the substrate table 74. In this flow, once setting of the substrate CB, the first light-shielding body 30 is kept on the rim of the substrate CB until the catoptric projection system 50 gives all the exposure areas EA to the exposure process. Only upon exchange of the processed substrates CB for another, the first light-shielding body 30 is moved to the escape location.

At the step S31, the rotary cylinder 33 rotates the first light-shielding body 30, thereby moving it to the escape location.

At the step S32, the substrate transport mechanism places the substrate CB on a vacuum chunk 79 of the substrate table 74, and the vacuum chunk 79 then starts holding the substrate CB so that it is fixed thereon.

At the step S33, the rotary cylinder 33 rotates the first light-shielding body 30 to partially cover the rim of the substrate CB.

At the step S34, the Y-stage 71 and the X-stage 73 move the substrate table 74 such that the exposure area EA sits under the catoptric projection system 50. The exposure location is controlled precisely by the laser interferometer.

At a step S35, the controller 90 moves the first light-shielding body positioning portion 32 in response to the movement of the substrate table 74 in order to move the first light-shielding body 30 to the predetermined location. Consequently, the first light-shielding body 30 defines the blind zone 39 where no patterns are to be formed.

At the step S36, the catoptric projection system 50 transfers the patterns of the photo-mask M to the photo-resist-coated surface of the substrate CB.

At a step S37, the controller 90 determines whether or not the catoptric projection system 50 has transferred the patterns of the photo-mask M to the whole surface area of the substrate CB. If the patterns are not yet transferred to the whole surface area (“No” at the step S37), then the process proceeds to the step S34. The above exposure process repeats. Otherwise, if the patterns have been fully transferred (“Yes” at the step S37), then the process proceeds to a finish process of a step S38. At the step S38, the first light-shielding body 30 is moved to the escape location, and the processed substrate CB is exchanged for another.

Since the first light-shielding body 30 is moved between blinding and escape positions for a short time, the projection exposure apparatus 100 gets ready to receive a new substrate CB onto the substrate table 74. Thus, the exposure process proceeds to the step S32 quickly, which results in the prompt process.

### EXAMPLE 2

### Laterally Movable Type Light-Shielding Body

In the example 1, the first light-shielding body 30 of the first light-shielding body positioning portion 32 rotates vertically, whereby the first light-shielding body 30 is moved between the blinding and escape locations. In contrast, in the example 2, the first light-shielding body 30 slides therebetween.

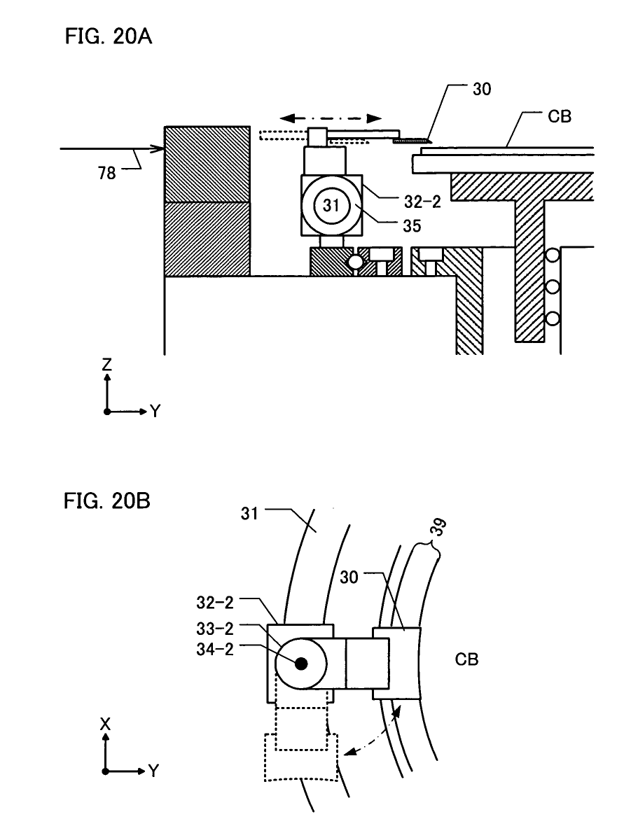

FIG. 20A shows a cross-section of a surrounding area of the first light-shielding body positioning portion 32-2 where the first light-shielding body 30 slides parallel to the X-Y plane. FIG. 20B shows the surrounding area of the first light-shielding body positioning portion 32-2 as seen from the top (on the Z axis).

The first light-shielding body 30 rotates around the rotational axis 34-2 by a rotary cylinder 33-2, thereby traveling between the escape location (plotted by dotted lines) and the blinding location (plotted by solid lines). As a result, the substrate CB is blinded appropriately. The width of a blind zone 39 can be adjusted by changing the size of the first light-shielding body 30. Consequently, the exposure area EA can be adjusted effectively. Furthermore, the lateral movement of the first light-shielding body 30 undergoes a lower air resistance than that of the vertical movement thereof. Accordingly, the lateral movement is less likely to cause the spread of contaminants.

The first light-shielding body 30 of FIG. 20B slidably rotates at 90 degree by the rotary cylinder 33-2, thus reaching the escape location. However, the present invention is not limited to this configuration. Alternatively, the first light-shielding body 30 may rotate at 180 degree unless touching the substrate CB. This movement mechanism may be implemented by the rotary cylinder 33-2 or a known stepping motor.

This projection exposure can also employ the flow of the exposure process of FIG. 18.

### EXAMPLE 3

### Multiple Light-Shielding Body Positioning Portions

In the above examples 1 and 2, the single light-shielding body positioning portion is used. However, multiple light-shielding body positioning portions may be provided. The specific example is as follows. The same reference numerals are applied to the same members of the example 1 or 2.

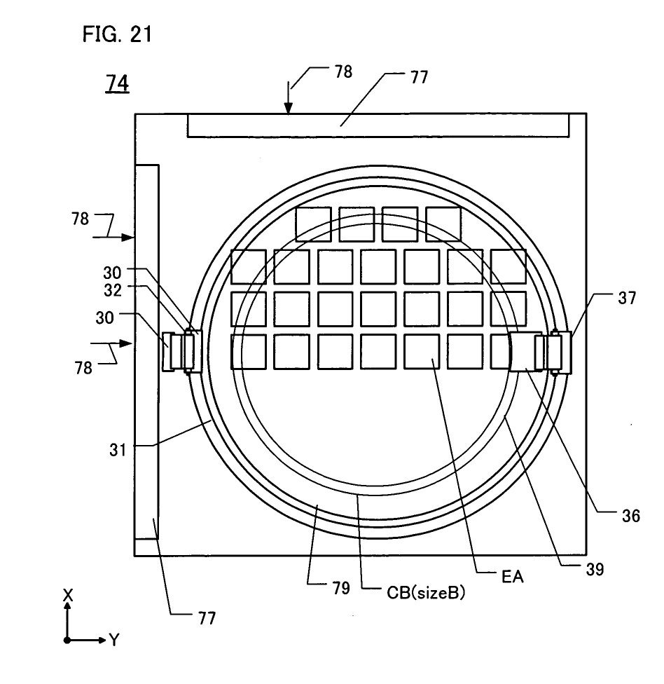

FIG. 21 shows the substrate table 74 having two light-shielding body positioning portions. Although a first light-shielding body positioning portion 32 and a second light-shielding body positioning portion 37 can travel freely on the guide rail 31, they must be configured not to collide with each other. In this drawing, the first and second light-shielding body positioning portions 32 and 37 are symmetric with respect to the center of the substrate CB, but they may be arranged adjacent to one another.

The two light-shielding body positioning portions 32 and 37 may have the light-shielding bodies of different sizes. To give an example, a first light-shielding body 30 for a substrate of a size A is provided on the first light-shielding body positioning portion 32, while a second light-shielding body 36 for a substrate of a size B is provided on the second light-shielding body positioning portion 37. In this case, the first light-shielding body 30 forms the blind zone 39 adapted for the substrate of the size A. Meanwhile, the second light-shielding body 36 has an incurved shape adapted for the substrate of the size B, and forms the blind zone 39.

FIG. 21 shows that the second light-shielding body 36 blinds the substrate of the size B, thereby defining the blind zone 39. While the substrate of the size B is subjected to the process, the first light-shielding body 30 is unnecessary. In this case, the first light-shielding body 30 is kept on the escape location as shown in FIG. 21. Upon exchange of the substrates, both the first and second light-shielding bodies 30 and 36 are moved to the respective escape locations.

A mechanism for rotating the light-shielding body may employ the retractable type as in the example 1 or the lateral movement type as in the example 2. The exposure process may execute the flowchart of FIG. 18. The material of the second light-shielding body 36 includes heatproof-coated titanium alloy, invar alloy of Fe-36Ni having a low thermal expansion coefficient, kovar alloy of Fe29Ni-17Co, and ceramic.

As described above, by providing the multiple light-shielding body positioning portions, the blind zone 39 can be created in accordance with substrates of various sizes, thereby presenting the general-purpose projection exposure apparatus 100.

### Second Embodiment: Another Method of Blinding Rim of Substrate>

FIG. 22 shows another method of blinding the rim of the substrate.

The substrate table 74 has a ring-shaped support stage 41 on which a light-shielding body 40 having a circular window is to be placed. The ring-shaped support stage 41 surrounds the substrate CB and the vacuum chuck 79, and is high enough not to make contact with the substrate CB. The light-shielding body 40 composed of multiple members is put on the support stage 41, while the center of the light-shielding body 40 is aligned with that of the substrate CB.

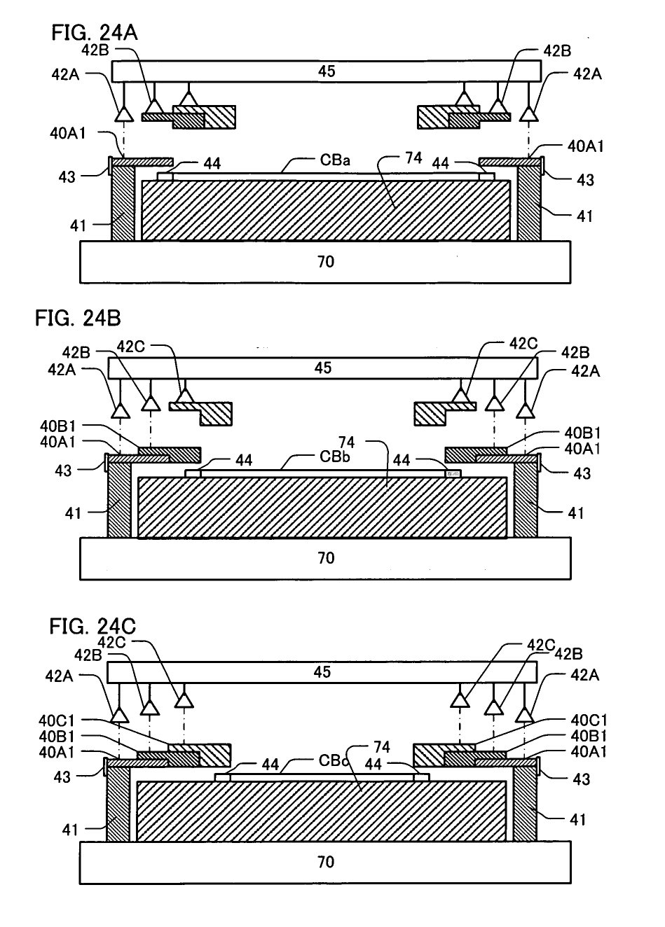

The light-shielding body 40 is fixed on the support stage 41 while being in contact with a guide 43 (see FIGS. 24A to 24C) Accordingly, even when the substrate table 74 moves, the light-shielding body 40 is not shifted. The support stage 41 does not need to be a single ring, and it may be constituted of several peaces. Specifically, the support stage 41 may be composed of three fan-shaped portions that are positioned at 0, 120 and 240 degrees with respect to the center of the vacuum chuck 79, respectively.

### EXAMPLE 4

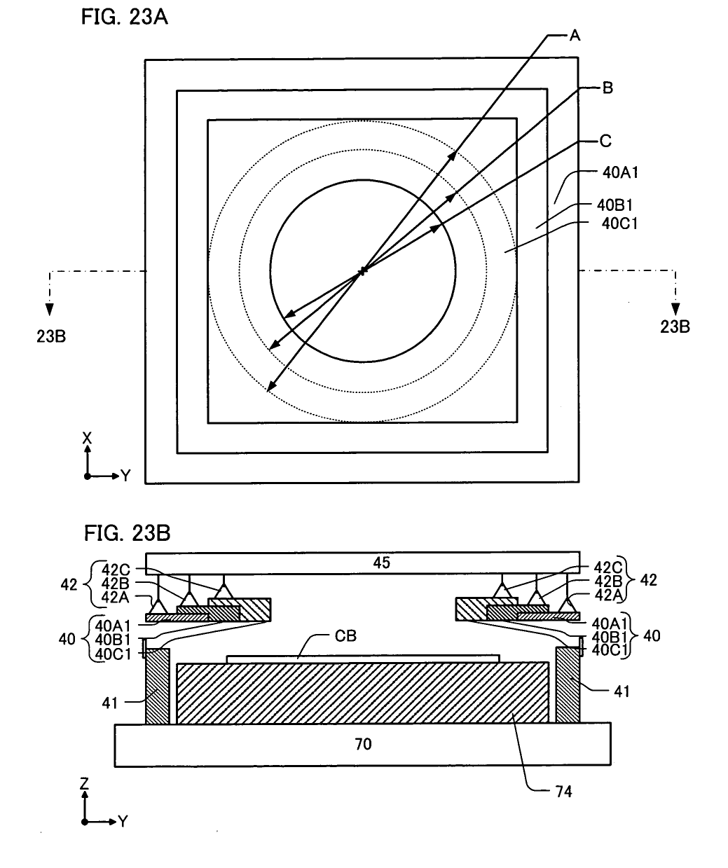

FIG. 23A shows the light-shielding body 40 composed of multiple members which is to be placed on the support stage 41 of the substrate table 74 as seen from the top. The light-shielding body 40 includes first, second and third light-shielding body members 40A1, 40B1, and 40C1. The first light-shielding body member 40A1 is placed at the outermost position of the three members and it has a circular window A of a first diameter. The second light-shielding body member 40B1 is placed between other two members, and it has a circular window B of a second diameter. The third light-shielding body member 40C1 is placed at the innermost position, and it has a circular window C of a third diameter. The first diameter is the largest of the three, while the third diameter is the smallest.

Each of the light-shielding body members 40A1, 40B1 and 40C1 has a rectangular frame-shape. The shape of its window depends on that of the substrate CB, and the window may have one or more projections or notches in accordance with the shape of the substrate CB. Its rectangular frame-shape advantageously protects wires or pipes around the vacuum chuck 79 from the ultraviolet light. In addition, this frame-shape is stronger than ring-shape and, thus resists deformation due to its weight. Moreover, it can have wider free space to which information such as bar codes can be written, thereby contributing to the decrease in human errors. If at least two outer lines of the frame-shape bodies of the three members are parallel to one another as shown in FIG. 23A, then they can be aligned by using the parallel lines as alignment marks.

FIG. 23B shows a cross-section of the surrounding area of the substrate table 74 taken along a D-D line of FIG. 23A. Referring to this drawing, the L-shaped light-shielding body member 40B1 is placed on the light-shielding body member 40A1 so as to overlap each other, and the light-shielding body member 40C1 is then placed on the light-shielding body member 40B1 in the same fashion. The bottom surfaces of the three light-shielding body members have the same level. The light-shielding body 40 of a predetermined size is to be set on a ring-shaped support stage 41.

The light-shielding body 40 is held by a vacuum section 42 of a light-shielding body holder 45. The vacuum section 42 holds it by means of negative air pressure or a magnetic force, and is composed of first, second and third vacuum section units 42A, 42B and 42C.

FIGS. 24A to 24C show a specific way to set the light-shielding body members 40A1, 40B1 and 40C1 of different sizes on the ring-shaped support stage 41.

FIG. 24A shows the setting of the first light-shielding body member 40A1 while the vacuum chuck 79 holds a substrate of a size CBa. The first vacuum section unit 42A stops its operation, so that the first light-shielding body member 40A1 is released from the vacuum section 42. As a result, the first light-shielding body member 40A1 is set on the support stage 41, and it is not shifted by the guide 43 coupled to the support stage 41. The first light-shielding body 40A1 makes it possible to form a blind zone 44 on the substrate CBa.

FIG. 24B shows the setting of the light-shielding body member 40B1 while the vacuum chuck 79 holds a substrate of a size CBb. The first and second vacuum section units 42A and 42B stop their operations, so that the first and second light-shielding body members 40A1 and 40B1 are released from the vacuum section 42. As a result, the first and second light-shielding body members 40A1 and 40B1 are set on the support stage 41, and the first light-shielding body member 40A1 is not shifted by the guide 43 coupled to the support stage 41. The second light-shielding body member 40B1 is not shifted by the first light-shielding body 40A1, either. The light-shielding body member 40B1 makes it possible to form the blind zone 44 on the substrate of the size CBb.

FIG. 24C shows the setting of the third light-shielding body member 40C1 while the vacuum chuck 79 holds a substrate of a size CBc. All the vacuum section units 42A, 42B and 42C of the vacuum section 42 stop their operations, so that all the light-shielding body members 40A1, 40B1 and 40C1 are released from the vacuum section 42. Consequently, the light-shielding body members 40A1, 40B1 and 40C1 are set on the support stage 41. The first light-shielding body 40A1 is not shifted by the guide 43 coupled to the support stage 41. The second light-shielding body member 40B1 is not shifted by the first light-shielding body member 40A1, and the light-shielding body member 40C1 is not shifted by the light-shielding body member 40B1. The light-shielding body member 40C1 makes it possible to form the blind zone 44 on the substrate of the size CBc.

The cross-section of the first light-shielding body member 40A1 is rectangular as shown in FIGS. 24A to 24C. Meanwhile, that of the second light-shielding body member 40B1 has an L-shape or a step. The second light-shielding body member 40B1 overlaps the inner radius area of the first light-shielding body member 40A1. Similarly, the third light-shielding body member 40C1 has an L-shape in cross-section, and overlaps the inner radius area of the light-shielding body member 40B1.

### EXAMPLE 5

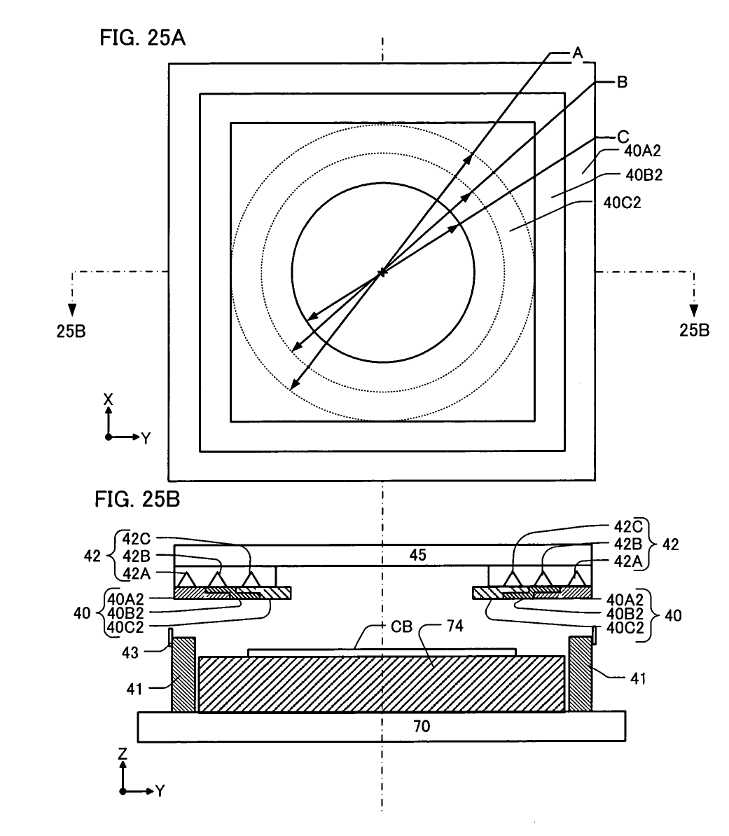

FIG. 25A shows a light-shielding body 40 to be set on the support stage 41 of the substrate table 74 as seen from the top. Similar to the example 4, the light-shielding body 40 includes first, second and third light-shielding body members 40A2, 40B2 and 40C2. The first light-shielding body member 40A2 is placed at the outermost position of the three members, and it has a circular window A of a first diameter. The second light-shielding body member 40B2 is placed between the first and third light-shielding body members 40A2 and 40C2, and it has a circular window B of a second diameter. The third light-shielding body member 40C2 is placed at the innermost position of the three, and it has a circular window C of a third diameter.

Each of the light-shielding body members 40A2, 40B2 and 40C2 has a rectangular frame-shape. The shape of its window depends on that of the substrate CB, and the window may have one or more projections or notches in accordance with the shape of the substrate CB. Similar to the example 4, the rectangular frame-shape is stronger than ring-shape and, thus resists deformation due to its weight.

FIG. 25B shows a cross-section of the surrounding area of the substrate table 74 taken along a line D-D of FIG. 25A. Referring to this drawing, the first light-shielding body member 40A2 has an L-shape in cross section, the second light-shielding body member 40B2 has a Z-shape, and the third light-shielding body member 40C2 is an L-shape. They are configured to overlap one another, and their bottom surfaces have the same level. The light-shielding body 40 is held by a vacuum section 42 of the light-shielding body holder 45, and the vacuum section 42 is composed of first, second and third vacuum section units 42A, 42B and 42C. The light-shielding bodies 40 of predetermined sizes are arranged on the support stage 41.

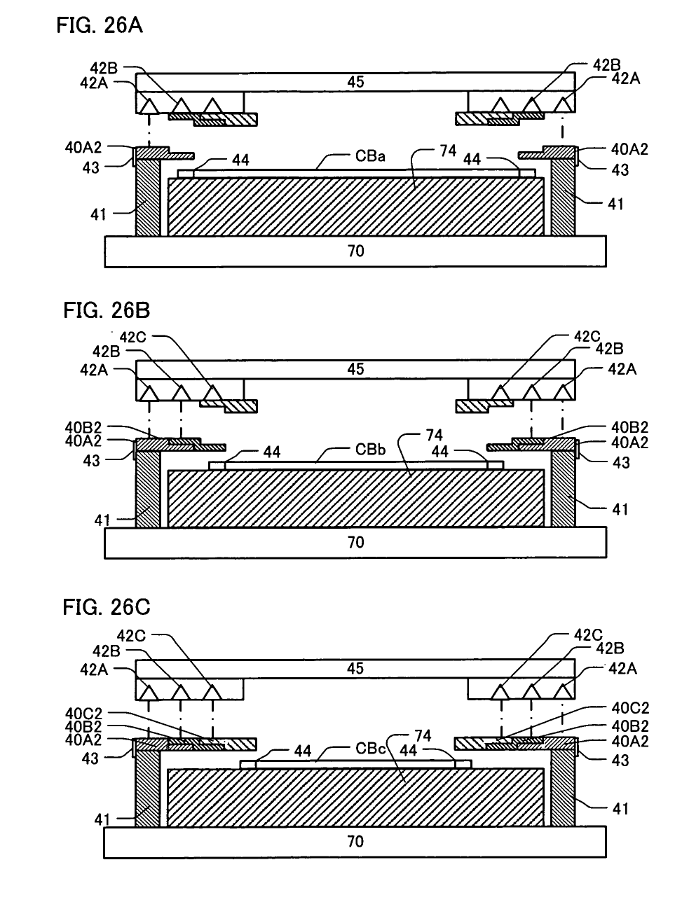

As with the example 4, FIGS. 26A to 26C show a way to set the light-shielding body members 40A2, 40B2 and 40C2 of different sizes.

FIG. 26A shows the setting of the first light-shielding body member 40A2 on the support stage 41, while the vacuum chuck 79 holds the substrate of the size CBa. The first vacuum section unit 42A stops its operation, so that the light-shielding body member 40A2 is released from the vacuum section 42. As a result, the light-shielding body member 40A2 is set on the support stage 41. Because being kept in contact with the inner surface of the guide 43 coupled to the support stage 41, the first light-shielding body member 40A2 is not shifted even when the substrate table 74 moves. The first light-shielding body member 40A2 makes it possible to form the blind zone 44 on the substrate of the size CBa.

FIG. 26B shows the setting of the second slight-shielding body member 40B2 on the support stage 41, while the vacuum chuck 79 holds the substrate of the size CBb. The first and second vacuum section units 42A and 42B stop their operations, so that the first and second light-shielding body members 40A2 and 40B2 are released from the vacuum section 42. Consequently, the light-shielding body 40 is set on the support stage 41. The first and second light-shielding body members 40A2 and 40B2 mate with each other, and they are fixed on the support stage 41. Thus, they are not shifted from one another even when the substrate table 74 moves. The second light-shielding body member 40B2 makes it possible to form the blind zone 44 on the substrate of the size CBb.

FIG. 26C shows the setting of the third light-shielding body member 40C2 on the support stage 41, while the vacuum chuck 79 holds the substrate of the size CBc. The first, second and third vacuum section units 42A, 42B and 42C stop their operations, so that the first, second and third light-shielding body members 40A2, 40B2 and 40C2 are set on the support stage 41. Those three light-shielding body members mate with one another. Hence, they are fixed on the support stage 41 while being integrated, and are not shifted from each other even when the substrate table 74 moves. In this way, the light-shielding body member 40C2 makes it possible to form the blind zone 44 on the substrate of the size CBc.

In the above examples 1 and 2, upon exchange of the substrate CB for another, the vacuum section 42 is activated. Then, the light-shielding body 40 is lifted away from the support stage 41 by means of the attracting power of the vacuum section 42. Following this, the substrate table 74 is moved to the exchange location, and it is exchanged for another substrate CB.

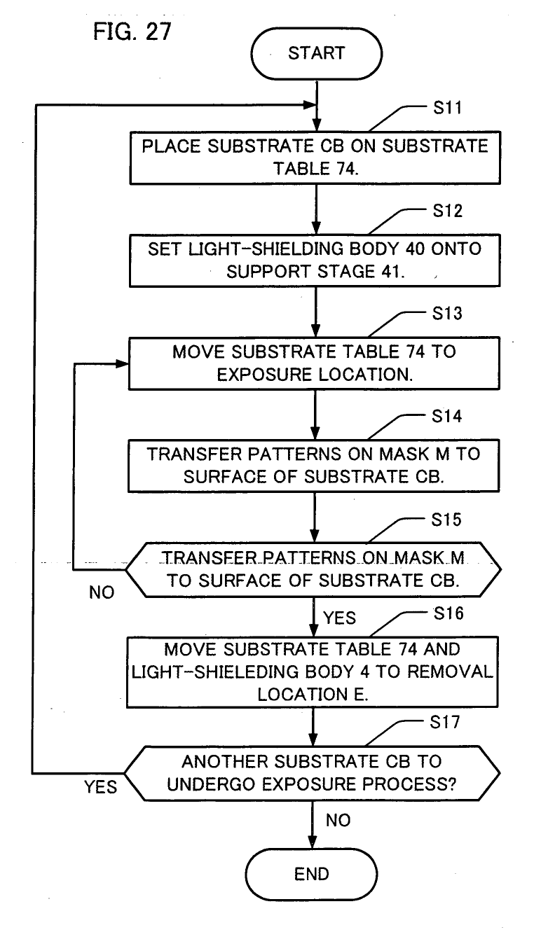

FIG. 27 shows a flow of the exposure process and the substrate exchange process. Note that a removal location E for the light-shielding body will be described later.

At a step S11, the substrate stage drive circuit 92 moves the substrate table 74 to the exchange location for the substrate CB, and a substrate transfer mechanism (not shown) places the substrate CB at the center of the substrate table 74. Subsequently, the vacuum chuck 79 placed under the substrate CB starts holding it.

At a step S12, the substrate stage drive circuit 92 moves the substrate table 74 to the removal location E for the light-shielding body. Then, the vacuum section 42 of the light-shielding body holder 45 sets the light-shielding body 40 onto the support stage 41.

At a step S13, the Y-stage 71 and the X-stage 73 move the substrate table 74 to a predetermined exposure location. In this case, the position of the substrate table 74 is controlled precisely by the laser interferometer.

At a step S14, the catoptric projection system 50 transfers the patterns of the photo-mask M to the photo-resist applied to the surface of the substrate CB. During the exposure process, the position of the substrate table 74 is controlled precisely by the laser interferometer. In this case, the two laser beams are irradiated to the substrate CB on the Y axis, so that the rotate direction of the substrate table 74 around the Z axis can also be controlled.

At a step S15, the controller 90 determines whether or not the exposure process has been executed to the whole surface area of the substrate CB. If it has not yet been done (“No” at the step S15), then the process returns to the step S13. Otherwise (“Yes” at the step S15), the exposure step is over, and the process proceeds to a step S16.

At the step S16, the substrate stage drive circuit 92 moves the substrate table 74 to the removal location E for the light-shielding body, and the light-shielding body 40 is removed from the support stage 41.

At the step S17, the controller 90 determines whether to give another substrate CB to the exposure process. If the exposure process continues (“Yes” at the step S17), then the process returns to the step S11. Otherwise (“No” at the step S17), the process is over.

As described above, even if the size of the substrate is changed in the course of the process, then the process does not need to be stopped. In this case, the light-shielding body 40 of the support stage 41 is simply changed. In addition, the step of exchanging the light-shielding bodies 40 can be done easily without risking damage on the substrate. In the examples 1 and 2, the light-shielding body 40 is removed at the removal location E. This removal location E is placed over wires connected to the substrate table 74. Accordingly, the light-shielding body 40 can be removed efficiently. A description will be given below, of the removal location E and a storage location for the light-shielding body 40.

### <Removal Location for Light-Shielding Body 40>

Assume that the removal location E for the light-shielding body 40 is provided near the mask stage support 85.

FIG. 28A shows a cross-section of the upper surrounding area of the substrate stage 70 as seen in the X direction. FIG. 28B shows the left side of the area of FIG. 28A.

For example, if the centers of the light-shielding body 40 and of the support body 41 are aligned with the removal location E on the X and Y axes of FIGS. 28A and 28B, then the light-shielding body 40 can be removed from the substrate CB. In this case, lifts 46 are attached to the mask stage support 85, and they travel the light-shielding body holder 45 vertically. Then, the light-shielding body 40 is exchanged for another. In FIGS. 28A and 28B, the light-shielding body 40 is one of the example 1. However, the light-shielding body 40 of the example 2 may be used instead. The storage location for the light-shielding body 40 must be provided not to make contact with the substrate table 74 and to disturb the exposure process. In consideration of this, the shape and location of the storage location need to be determined.

The substrate table 74 on which the light-shielding body 40 has been set at the removal location E traverses the center F of where the exposure process is executed. Therefore, the distance at which the substrate table 74 needs to move is short, thereby enhancing the process efficiency. In other words, the removal location E is placed near the area where the catoptric projection system 50 carries out the exposure process.

In the embodiment, the lifts 46 are installed on the mask stage support 85. However, the present invention is not limited to this configuration. The lifts 46 can be installed on any location as long as its vertical movement does not affect other members. For example, the lifts 46 maybe installed on the support stage 83.

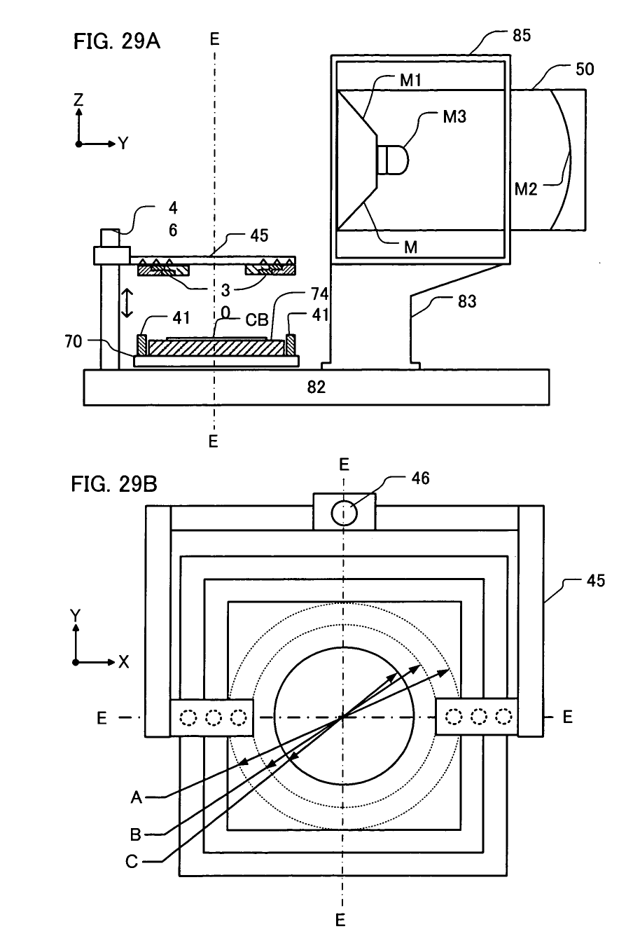

Next, assume that the removal location E for the light-shielding body 40 is provided at the rim of the substrate stage 70. FIG. 29A shows a cross-section of an upper surrounding area of the substrate stage 70 as seen in the X direction. FIG. 29B shows the removal location E of FIG. 29A as seen from the top. In this embodiment, the substrate table 74 is moved to the removal location E on the X and Y axes, and then, the center of the support body 41 is aligned with that of light-shielding body 40. A base 82 of the substrate stage 70 is equipped with a lift 46 thereon, and the lift 46 travels vertically, thus removing light-shielding body 40 from the support stage 42. In FIGS. 29A and 29B, the light-shielding body 40 is one of the example 2. However, the light-shielding body 40 of the example 1 may be used instead. In this case, the storage location for the light-shielding body 40 needs to be defined so as not to interfere with the movement of the substrate table 74 and the exchange of the substrates.

By applying the removal location E on the substrate stage 70, the design of the projection exposure apparatus 100 is made flexible. Furthermore, the light-shielding body 40 can be removed close to the exchange location for the substrate CB. This makes it possible to exchange the substrates CB and remove the light-shielding body 40 at the same time without traveling the substrate table 74.

Moreover, the lift 46 of the light-shielding body holder 45 needs to have a device that can control the vertical movement precisely, such as a cylinder device or a driving motor with a guide.

With the above process, the light-shielding body 40 of any size can be removed. Therefore, it is possible to form the blind zone 44 in accordance of the substrate CB of any size. This makes it possible to provide the general-purpose, efficient projection exposure apparatus 100

From the aforementioned explanation, those skilled in the art ascertain the essential characteristics of the present invention and can make the various modifications and variations to the present invention to adapt it to various usages and conditions without departing from the spirit and scope of the claims.

What is claimed is;:

1. A projection exposure apparatus for forming patterns onto a substrate, comprising:
a mask-stage for holding a photo-mask having predetermined patterns thereon;
a light source for emitting a light ray containing a plurality of spectral lines including g, h, i and j-lines;
a wavelength selector for selecting a light ray containing one or more predetermined spectral lines from the light ray emitted from the light source;
an illumination optical.-system for irradiating the photo-mask with the selected light ray;
an Offner type projection system for projecting the light ray having passed through the photo-mask onto the substrate;
a substrate stage including a vacuum portion for holding the substrate, the substrate stage for positioning the substrate; and
a light-shielding body for partially blocking the light irradiated to the substrate.

2. The projection exposure apparatus according to claim 1,
wherein the Offner type projection system includes a barrel having a circumference on which a plurality of polygonal openings are formed, and the barrel comprises:
a first mirror for reflecting the light having passed through the photo-mask;
a second mirror for reflecting the light having been reflected by the first mirror;
a third mirror for reflecting the light having been reflected by the second mirror; and
a fourth mirror for reflecting the light having been reflected by the third and second mirrors in this order.

3. The projection exposure apparatus according to claim 2,
wherein a shape of the openings comprises a triangle and a hexagon.

4. The projection exposure apparatus according to claim 2,
wherein the barrel comprises a first barrel for holding the first, third and fourth mirrors and a second barrel for holding the second mirror.

5. The projection exposure apparatus according to claim 1,
wherein the light-shielding body comprises:
a first light-shielding body for blocking the light;
a first light-shielding body positioning portion for placing the first light-shielding body above a rim of the substrate; and
a moving portion for traveling the first light-shielding body positioning portion to any given location around the substrate, the moving portion being placed on the substrate stage.

6. The projection exposure apparatus according to claim 5,
wherein the moving portion comprises a circular guide rail located around the vacuum portion of the substrate stage.

7. The projection exposure apparatus according to claim 5,
wherein the first light-shielding body positioning portion rotates around an axis that is parallel to the substrate.

8. The projection exposure apparatus according to claim 5,
wherein the first light-shielding body positioning portion slides in parallel with the substrate.

9. The projection exposure apparatus according to claim 5,
wherein the light-shielding body further comprises a second light-shielding body positioning portion including a second light-shielding body that has a different shape from that of the first light-shielding body, and the second light-shielding body positioning portion positions the second light-shielding body above the rim of the substrate, and
wherein the moving portion travels the second light-shielding body positioning portion to any given location around the substrate.

10. The projection exposure apparatus according to claim 9,
wherein a distance between the second light-shielding body and a center of the substrate is different from that between the first light-shielding body and the center.

11. The projection exposure apparatus according to claim 1,
wherein the light-shielding body comprises:
a first light-shielding body having a circular window of a first diameter, the first light-shielding body for blocking the light;
a second light-shielding body having a circular window of a second diameter, the second light-shielding body for blocking the light while overlapping the first light-shielding body;
a support unit being provided around the vacuum portion of the substrate stage, the support unit for supporting the first light-shielding body over the substrate; and
a driver for moving the first and second light-shielding bodies over the substrate.

12. The projection exposure apparatus according to claim 11,
wherein an outer frame of each of the first and second light-shielding bodies has a rectangular shape, and the window thereof has a circular shape, and
wherein the first diameter is larger than the second diameter.

13. The projection exposure apparatus according to claim 11,
wherein the light-shielding body further comprises a vacuum unit for holding the first and second shielding bodies, and the vacuum unit is operated by the driver.

14. The projection exposure apparatus according to claim 1,
wherein the wavelength selector comprises a plurality of optical filters, each of which pass therethrough the light ray containing at least two spectral lines from among the g, h, i and j-lines, and the optical filters are placed on a pupil conjugate plane of the Offner type projection system or on a conjugate plane of the photo-mask.

15. The projection exposure apparatus according to claim 14,
wherein the wavelength selector comprises a first wave-length selector and a second wavelength selector which are arranged away from each other on an axis of the light, the first and second wavelength selectors include some of the optical filters and the others, respectively, and
wherein a spectral range of the light ray that passes through the wavelength selector is determined based on a combination of one of the optical filters of the first wavelength selector and one of the optical filters of the second wavelength selector.

16. The projection exposure apparatus according to claim 1, further comprising:
a mark detector for detecting first and second alignment marks on the photo-mask; and
a controller for computing a position of the photo-mask based on a result detected by the mark detector.

17. The projection exposure apparatus according to claim 1, further comprising a mask light-shielding body for partially blocking the light irradiated to the photo-mask, the mask light-shielding body including two first blades, each of which has at least one linear edge and at least one curved edge, the first blades being movable on a first axis.

18. The projection exposure apparatus according to claim 17,
wherein the mask light-shielding body further comprises two second blades that are movable on a second axis perpendicular to the first axis.

19. The projection exposure apparatus according to claim 17,
wherein the mask light-shielding body defines a rectangular or substantially arc-shaped space.

20. The projection exposure apparatus according to claim 1, further comprising an exposure type selector for selecting one of a first exposure system and a second exposure system,
wherein the first exposure system is to form the patterns while both the mask stage and the substrate stage are stationary and the second exposure system is to form the patterns while the mask stage and the substrate stage are moved in synchronization with each other.
